(19) United States
(12) Patent Application Publication
(10) Pub. No.: US 2017/0054538 A1
(43) Pub. Date: Feb. 23, 2017

(54) MOBILE TERMINAL DEVICES AND METHODS OF DETECTING REFERENCE SIGNALS

(71) Applicant: Intel IP Corporation, Santa Clara, CA (US)

(72) Inventor: Tian Yan Pu, Santa Clara, CA (US)

(21) Appl. No.: 14/830,797

(22) Filed: Aug. 20, 2015

(51) Int. Cl. H04L 5/00; H04W 72/04; H04W 56/00

(52) U.S. Cl. CPC H04L 5/0048; H04W 56/001; H04W 72/0446; H04W 72/042

(57) ABSTRACT

A method of detecting reference signals may include calculating one or more correlation values, wherein each of the one or more correlation values representing a correlation between a digitally-sampled communication signal and a respective reference signal; applying a predefined criteria to the one or more correlation values to determine whether to exclude the one or more correlation values from a peak correlation database, the peak correlation database containing the remaining one or more correlation values; and detecting one or more transmitted reference signals within the digitally-sampled communication signal using the peak correlation database.

### TECHNICAL FIELD

Various embodiments relate generally to methods for detecting reference signals, mobile terminal devices, and mobile baseband modems.

### BACKGROUND

Mobile communication terminals may utilize reference signals to perform both initial timing synchronization and synchronization tracking with one or more network access points in a mobile communication network. In an exemplary Long Term Evolution (LTE) network configuration according to the Third Generation Partnership Project (3GPP), mobile communication terminals may utilize Primary Synchronization Signals (PSSs), Secondary Synchronization Signals (SSSs), and Cell-specific Reference Signals (CRSs) received from one or more base stations in order to obtain and maintain timing synchronization. Initial timing synchronization may be dependent on properly detecting and identifying locations of PSS sequences within a received downlink signal. A mobile communication terminal may identify half-frame timing boundaries (thereby obtaining slot synchronization) and sector identities (sector IDs) of one or more cells through proper PSS detection. The initial timing synchronization and sector IDs may then be utilized to further synchronize communications between the mobile communication terminal and the one or more cells, such as by utilizing SSSs and CRSs to refine the initial timing synchronization.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an exemplary downlink radio frame structure;

FIG. 2 shows an exemplary received downlink signal relative to a mobile terminal containing multiple synchronization sequences;

FIG. 3 shows an exemplary internal configuration of a mobile terminal;

FIG. 4 shows an exemplary internal configuration of a baseband modem;

FIG. 5 shows an improved PSS detection procedure according to an exemplary aspect of the disclosure;

FIG. 6 shows an improved PSS detection procedure according to another exemplary aspect of the disclosure;

FIG. 7 shows a block diagram illustrating an improved PSS detection procedure;

FIG. 8 shows an exemplary Batcher network for minimum searching

FIG. 9 shows a method for detecting reference signals according to a first exemplary aspect of the disclosure; and

FIG. 10 shows a method for detecting reference signals according to a second exemplary aspect of the disclosure.

### DESCRIPTION

The following details description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as peak or advantageous over other embodiments or designs.

The words “plural” and “multiple” in the description and the claims, if any, are used to expressly refer to a quantity greater than one. Accordingly, any phrases explicitly invoking the aforementioned words (e.g. “a plurality of [objects]”, “multiple [objects]”) referring to a quantity of objects is intended to expressly refer more than one of the said objects. The terms “group”, “set”, “collection”, “series”, “sequence”, “grouping”, “selection”, etc., and the like in the description and in the claims, if any, are used to refer to a quantity equal to or greater than one, i.e. one or more. Accordingly, the phrases “a group of [objects]”, “a set of [objects]”, “a collection of [objects]”, “a series of [objects]”, “a sequence of [objects]”, “a grouping of [objects]”, “a selection of [objects]”, “[object] group”, “[object] set”, “[object] collection”, “[object] series”, “[object] sequence”, “[object] grouping”, “[object] selection”, etc., used herein in relation to a quantity of objects is intended to refer to a quantity of one or more of said objects. It is appreciated that unless directly referred to with an explicitly stated plural quantity (e.g. “two [objects]” “three of the [objects]”, “ten or more [objects]”, “at least four [objects]”, etc.) or express use of the words “plural”, “multiple”, or similar phrases, references to quantities of objects are intended to refer to one or more of said objects.

As used herein, a “circuit” may be understood as any kind of logic (analog or digital) implementing entity, which may be special purpose circuitry or a processor executing software stored in a memory, firmware, hardware, or any combination thereof. Furthermore, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”. It is understood that any two (or more) of the described circuits may be combined into a single circuit with substantially equivalent functionality, and conversely that any single described circuit may be distributed into two (or more) separate circuits with substantially equivalent functionality.

As used herein, “memory” may be understood as an electrical component in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc. Furthermore, it is appreciated that shift registers, processor registers, data buffers, etc., are also embraced herein by the “term” memory. It is appreciated that a single component referred to as “memory” or “a memory” may be composed of more than one different type of memory, and thus may refer to a collective component comprising one or more types of memory. It is readily understood that any single memory “component” may be distributed or/separated multiple substantially equivalent memory components, and vice versa. Furthermore, it is appreciated that while “memory” may be depicted, such as in the drawings, as separate from one or more other components, it is understood that memory may be integrated within another component, such as on a common integrated chip.

The term “base station” used in reference to an access point of a mobile communication network may be understood as a macro base station, micro base station, Node B, evolved NodeBs (eNB), Home eNodeB, Remote Radio Head (RRHs), relay point, etc.

As used herein, a “cell” in the context of telecommunications may be understood as a sector served by a base station. Accordingly, a cell may be a set of geographically co-located antennas that correspond to a particular sectorization of a base station. A base station may thus serve one or more “cells” (or sectors), where each cell is characterized by a distinct communication channel. Furthermore, the term “cell” may be utilized to refer to any of a macrocell, microcell, femtocell, picocell, etc.

It is appreciated that the ensuing description may detail exemplary scenarios involving mobile device operating according to certain 3GPP (Third Generation Partnership Project) specifications, notably Long Term Evolution (LTE) and Long Term Evolution-Advanced (LTE-A). It is understood that such exemplary scenarios are demonstrative in nature, and accordingly may be similarly applied to other mobile communication technologies and standards. The examples provided herein are thus understood as being applicable to various other mobile communication technologies, both existing and not yet formulated, particularly in cases where such mobile communication technologies share similar features as disclosed regarding the following examples.

The term “network” as utilized herein, e.g. in reference to a communication network such as a mobile communication network, is intended to encompass both an access component of a network (e.g. a radio access network (RAN) component) and a core component of a network (e.g. a core network component).

As utilized herein, the term “idle mode” used in reference to a mobile terminal refers to a radio control state in which the mobile terminal is not allocated at least one dedicated communication channel of a mobile communication network. The term “connected mode” used in reference to a mobile terminal refers to a radio control state in which the mobile terminal is allocated at least one dedicated communication channel of a mobile communication network.

Conventional mobile communication networks may rely on proper timing synchronization between user equipment (UE) and base stations in order to function effectively. In Long Term Evolution (LTE) networks configured according to Third Generation Partnership Project (3GPP) specifications, UEs may utilize reference signals such as Primary Synchronization Signals (PSSs), Secondary Synchronization Signals (SSSs), and Cell Specific Reference Signals (CRSs) received from base stations (known as eNodeBs or eNBs in LTE networks) in order to obtain initial timing synchronization and perform timing synchronization tracking therewith. The accuracy of timing synchronization may have a direct impact on a variety of UE procedures including initial Public Land Mobile Network (PLMN) search (e.g. for initial network attachment) and neighbor cell detection (e.g. including cell selection/reselection and handover).

Due to the largely asynchronous nature of cells relative to one another in LTE network configurations, a UE may need to first establish timing synchronization with an observable cell before exchanging any communication data therewith. Specifically, a UE may need to identify timing boundaries within a downlink signal received from a cell, such as e.g. radio frame and half-frame boundaries, in order to properly define the timing schedule to be used for data reception and transmission with the cell.

A UE may thus receive and evaluate a downlink signal, e.g. a synchronization signal transmitted by a cell, in order to obtain such timing synchronization with a cell. Due to the relatively dense spatial distribution of cells within cellular communication network areas, a UE may receive downlink signals containing transmissions that originate from multiple cells (e.g. where the cells utilize the same carrier frequency). A UE may then obtain timing synchronization with the detectable cells by analyzing the downlink signal, such as by identifying the timing location of synchronization signals from the corresponding detectable cells within a received downlink signal.

UEs may apply PSS detection to a received downlink signal as part of initial timing synchronization procedures in order to determine half-frame boundaries (thereby also obtaining slot synchronization) and sector identities (sector IDs) of one or more given detectable cells. As specified by 3GPP, cells may periodically transmit PSS sequences at predefined time and frequency locations within each downlink LTE frame. A UE may thus analyze a received downlink signal in order to determine the temporal location (i.e. timing location) of each observable PSS sequence, thereby determining the PSS timing location associated with each respective detectable cell. As PSS sequence transmissions are periodic with a single half-frame period, UEs may obtain slot synchronization with each cell (i.e. by identifying the half-frame boundary and extrapolating the half-frame boundary to define the slot boundary) by determining the location of PSS sequence of each cell within the received downlink signal.

In order to detect PSS sequences within a received downlink signal, a UE may rely on the fact that the set of potential PSS sequences is predefined. As specified by 3GPP, each cell may transmit one of three possible PSS sequences, where each possible PSS sequence is a predefined sequence of symbols. As the possible PSS sequences are predefined, a UE may perform a comparison between a received downlink signal and each of the predefined possible PSS sequences in order to determine if any timing points in the downlink signal produce a “match” with one of the predefined possible PSS sequences. A UE may then identify a predefined PSS sequence (corresponding to one of the three possible PSS sequences) that produces a match at a certain point in time. As will be detailed, the UE may then utilize the timing location of the PSS sequence and the matching predefined PSS sequence in order to initialize timing synchronization and determine partial identification information of the cell. The UE may then finalize the timing synchronization (radio frame synchronization) and obtain the full cell identity (physical cell identity (PCI)) using SSS detection.

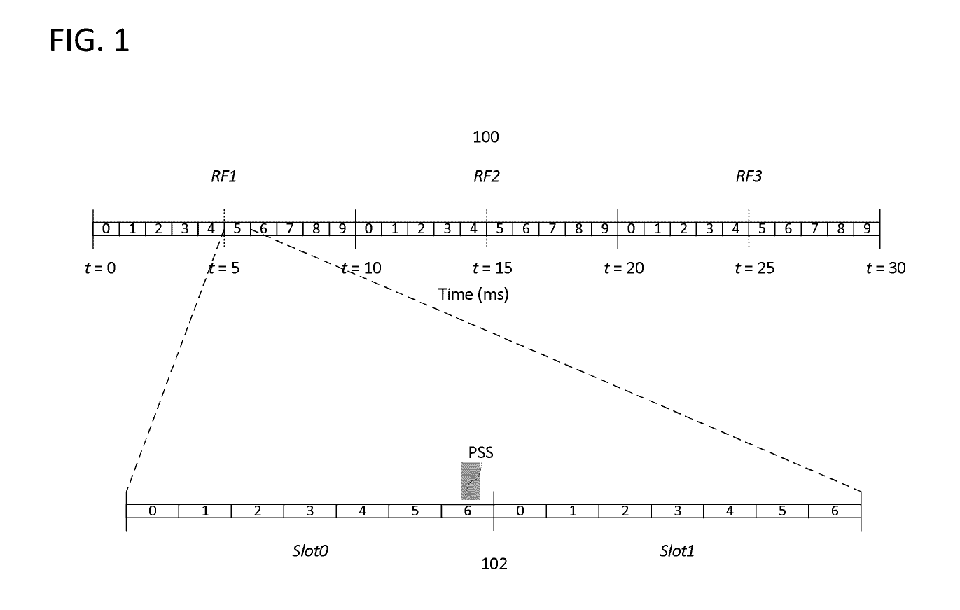

FIG. 1 shows an exemplary downlink radio frame structure 100 and downlink subframe structure 102. While downlink radio frame structure 100 and downlink subframe structure 102 may be consistent with radio frame and subframe structures as conventionally utilized in LTE network configurations, it is appreciated that various other mobile communication protocols may utilize similar “discretized” scheduling structures, where the scheduling structures may vary according to interval durations and/or number of intervals. It is thus understood that the teachings detailed herein may be readily applied to many such alternate mobile communication protocols, in particular mobile communication protocols that utilize periodic reference signals in order to obtain timing synchronization.

Downlink radio frame structure 100 as depicted in FIG. 1 includes radio frames RF1, RF2, and RF3 (although it is appreciated that downlink radio frame structure 100 may be of a substantially longer finite or infinite duration, i.e. may be composed of multiple additional radio frames). Each of radio frames RF1-RF3 may be composed of 10 subframes SF0-SF9, where each subframe may be 1 ms in duration. Each subframe may be structured as depicted by downlink subframe structure 102, and accordingly may be divided into 2 slots (slots Slot0 and Slot1) each of 0.5 ms duration, where each slot contains 7 symbols Sym0-Sym6 (or e.g. 6 symbols in the case of extended cyclic prefix).

Each symbol duration Sym0-Sym6 may contain downlink data, such as data traffic, control data, reference signals, synchronization signals, etc. Although not explicitly depicted in FIG. 1, each cell may utilize multiple subcarriers to transmit such data during each timing interval (i.e. each radio frame, half-frame, subframe, and symbol). In an LTE configuration, each cell may utilize between 6 and 100 resource blocks, where each resource block is composed of 12 subcarriers spaced apart by 15 KHz. Each cell may thus utilize between 72 and 1200 subcarriers to transmit downlink data in accordance with the system bandwidth.

As specified by 3GPP, PSS sequences may be located in the last symbol (i.e. Sym6) of the first and tenth slots of each radio frame (i.e. Slot0 of subframes SF0 and SF5), and thus may be repeated every 5 ms (i.e. once per half radio frame, or “half-frame”) over a single symbol duration. Such PSS locations are depicted in FIG. 1 as gray-shaded intervals. For example, subframes SF0 and SF5 of each of radio frames RF1-RF3 may contain PSS sequence data at Sym6 of Slot0.

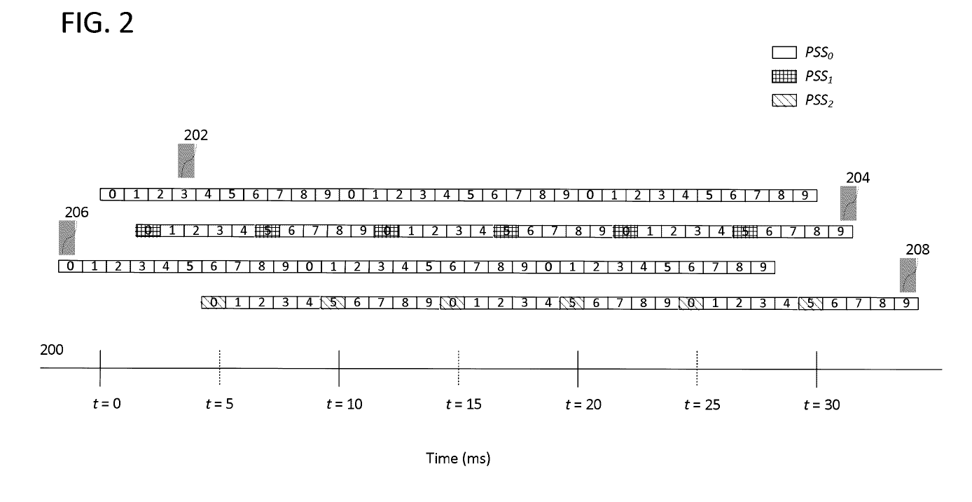

Downlink radio frame structure 100 may correspond to the downlink transmissions of downlink LTE transmission of a single cell. As a UE may be proximate to multiple such cells, downlink signals received by the UE may be composed of several such downlink radio frame structures, where each downlink radio frame structure is associated with a different cell. As previously indicated, LTE cells may be largely asynchronous to one another in the time domain, and accordingly a UE may receive a downlink signal containing PSS sequences from different cells located at differing timing locations to one another. FIG. 2 shows such an example in which four different cells may each transmit downlink signals respectively according to downlink frame structures 200-204. The resulting downlink signal received by a UE may thus contain multiple PSS sequences each located at various different timing locations. The UE may then identify the timing location of each PSS sequence and the PSS sequence identity (out of the three possible predefined PSS sequences) as part of PSS detection.

As each cell may periodically transmit a PSS sequence according to a half-frame period (i.e. every 5 ms), a UE may determine the half frame boundary of each observable cell by identifying the timing location of each PSS sequence, thereby obtaining an initial level of synchronization with the cell (slot synchronization). It is appreciated that SSS detection may then be utilized obtain frame synchronization.

A UE may also determine initial identification information of each observable cell based on the detectable PSS sequences. Each cell in an LTE network may be assigned a Physical Cell Identity (PCI), which ranges in value from 0-503. Each PCI may be based on the cell group identity N_{ID,1} (referred to herein as “group ID”), ranging from 0-167, and the cell sector ID N_{ID,2} (referred to herein as “sector ID”), ranging from 0-167, where PCI=3*N_{ID,1}+N_{ID,2}. PCI may play an important factor in network planning, including controlling the location of certain reference signals (such as CRS) within downlink signals transmitted by cells.

Each cell may transmit one of three possible PSS sequences, PSS₀, PSS₁, or PSS₂, with PSS sequence index 0, 1, or 2 respectively corresponding to an assigned sector IDs N_{ID,2}=0, 1, or 2 for each cell. As a result, a UE may also determine the sector ID of each observable cell by specifically identifying which PSS sequence PSS₀, PSS₁, or PSS₂ each cell is transmitting, i.e. by identifying the PSS sequence index utilized by a given cell. Although not explicitly detailed herein, a UE may subsequently utilize SSS detection in order to determine the group ID N_{ID,1} of a cell, thereby obtaining the complete PCI of the cell.

Each possible PSS sequence may be predefined, and thus may be known by a UE prior to any synchronization procedures. As specified by 3GPP for LTE network configurations, each PSS sequence PSS₀, PSS₁, and PSS₂ is a sequence of 62 complex symbols based on a Zadoff-Chu sequence, where each of PSS₀, PSS₁, and PSS₂ utilizes a different root for the Zadoff-Chu root sequence index.

As specified by 3GPP, each cell may divide the allotted downlink bandwidth into multiple subcarriers spaced by 15 kHz and transmit a different symbol on each subcarrier during each symbol interval. Cells may thus map the assigned 62-symbol length PSS sequence to the 62 subcarriers surrounding the central DC subcarrier and transmit the resulting signal according to the timing locations detailed regarding FIG. 1, i.e. in the last symbol in Slot0 of subframes SF0 and SF5.

As cells are largely asynchronous relative to each other in LTE networks, UEs may receive a downlink signal including PSSs transmitted from multiple nearby cells, where the PSSs are located at substantially different timing locations from the perspective of the UE. Such an example is depicted in FIG. 2, showing downlink sequences 202-208 plotted against time axis 200. Each of downlink sequences 202-208 may be transmitted by a different cell. Accordingly, a UE receiving downlink signals may receive each of downlink sequences 202-208 aggregated over top of one another (where time axis 200 is the time relative to the UE).

As depicted by the varying fill patterns of each SF0 and SF5 subframes of downlink sequences 202-208, the respective cells transmitting each of downlink sequences 202-208 may utilize a different PSS sequence PSS₀, PSS₁, and PSS₂. Accordingly, a UE in proximity the cells corresponding to downlink sequences 202-208 may receive an aggregated symbol containing different PSS sequences PSS₀, PSS₁, and PSS₂ staggered at varying times. The UE may obtain synchronization with each corresponding cell by determining the timing location of each PSS sequence within each of downlink sequences 202-208, thereby obtaining slot synchronization. The UE may also obtain initial (partial) cell identification in the form of sector ID by determining which of PSS sequences PSS₀, PSS₁, or PSS₂ each cell is transmitting.

Accordingly, a UE may compare each input sample of a half-frame of a received downlink signal with a local copy of each possible PSS sequence in order to identify if any of the input samples produce a “match” with one of the local PSS sequences. Input sample and PSS sequence pairs (i.e. PSS candidates) producing a strong “match” may thus be interpreted as the timing location of a specific PSS sequence within the received downlink signal half-frame, which may therefore indicate the presence of a nearby cell transmitting the PSS sequence. A UE may then establish an initial level of synchronization with the cell as well as obtain partial identity information of the cell.

PSS detection procedures may rely on the unique autocorrelation properties of PSS sequences, which exhibit essentially zero autocorrelation for all non-zero lags in the frequency domain. As this autocorrelation largely carries over into the time domain, a UE may calculate the cross-correlation between each input sample of the received downlink signal and each of the local PSS sequences in order to identify timing samples exhibiting “peak” cross-correlation values with the local PSS sequences (i.e. high-valued cross-correlation values). PSS candidates having high cross-correlation values may indicate a high probability/likelihood that a proximate cell is transmitting the associated PSS sequence commencing at the associated input sample.

Assuming the presence of PSS sequences in the received downlink signal, a UE may thus obtain one or more input samples exhibiting peak correlation values, which may thus indicate the presence of one or more PSS sequences beginning at the corresponding peak input samples. Accordingly, a UE may calculate the cross-correlation between each input sample of a downlink signal half-frame and each local PSS sequence copy in order to identify the timing location of PSS sequences within the downlink signal half-frame on a per-input sample basis.

As each cell may transmit the specific assigned PSS sequence repetitively with a 5 ms period, a UE may obtain half-frame boundaries with each detectable cell by determining the timing location (i.e. by virtue of the input sample producing a peak correlation) of each PSS sequence contained in the downlink signal. As each peak correlation will correspond to both an input sample and a local PSS sequence copy, a UE may also identify the sector ID of each detectable cell by virtue of the sector ID of the associated local PSS sequence copy (i.e. having a PSS sequence index of 0, 1, or 2 corresponding to PSS sequence PSS₀, PSS₁, or PSS₂). Each peak cross-correlation value may thus be associated with an input sample and a PSS sequence index (sector ID), where the PSS sequence index corresponds to the PSS sequence which produced the peak cross-correlation value.

The input sample and PSS sequence index (sector ID) associated with such peak cross-correlation values may thus be the outputs of PSS detection, where the input sample is identified by the index of the input sample within a half-frame of input samples. The input sample index may thus correspond to the half-frame boundary associated a cell, which may also yield slot synchronization. The PSS sequence index may yield the sector ID of the cell. The resulting peak PSS candidates may then be utilized for further cell synchronization and identification procedures, such as SSS detection (frame synchronization and full PCI determination) and time tracking using CRS.

Due to the 5 ms periodicity (i.e. once per-half-frame) of PSS sequences, a UE may perform PSS detection on a per-half-frame basis in order to detect each observable PSS sequence within a downlink signal (as each cell may transmit the assigned PSS sequence once per half-frame). By evaluating the cross-correlation between each input sample of a downlink signal half-frame and each local PSS sequence copy, a UE may evaluate each input sample as a potential PSS sequence timing location within each downlink signal half-frame. The peak PSS candidates (input sample index-PSS sequence index pairs having high cross-correlation) from a single half-frame may thus be utilized to output PSS detection data.

While such evaluation of a single half-frame of downlink data may be sufficient to obtain initial cross-correlation values for each input sample and PSS ID pair (i.e. PSS candidate), use of only a single half-frame of downlink data may be particularly susceptible to corruption from noise and interference. As opposed to utilizing a single half-frame, a UE may intermittently sum the cross-correlation values for each PSS candidate over multiple half-frames, thereby obtaining a more robust cross-correlation value less vulnerable to noise and interference.

After summing the cross-correlation values for each PSS candidate over multiple half-frames, a UE may select a set of “peak” PSS candidates with maximum summed cross-correlation metrics, where each peak PSS candidate is characterized by an input sample (identified by input sample index) and PSS sequence index (sector ID) corresponding to the associated PSS sequence. The UE may then utilize the input samples and PSS sequence indices (sector IDs) of the peak PSS candidates as the outputs of PSS detection. The outputted input samples (i.e. timing locations corresponding to the input sample index) and sector IDs (i.e. PSS sequence index) of the peak PSS candidates may be for later synchronization procedures, including SSS detection for frame synchronization and PCI determination. As the received downlink signal to which a UE applies PSS detection may contain downlink signals received from multiple cells, PSS detection may be utilized to initiate synchronization with multiple cells.

The above-detailed procedure, referred to as PSS detection, may be summarized as follows:
a) For each input sample per half-frame of received downlink data: calculate the cross-correlation with each of the three possible PSS sequences (locally generated or stored) to generate a cross-correlation value for each input sample index-PSS sequence index (sector ID) pair (i.e. “PSS candidate”)
b) Sum together cross-correlation values for each input sample index-PSS sequence index (sector ID) pair over multiple half-frames to mitigate noise and interference, thus generating a summed cross-correlation value for each input sample index-PSS sequence index (sector ID) pair
c) Select input sample index-PSS sequence index (sector ID) pairs with maximum summed cross-correlation values as the outputs of PSS detection (i.e. “peak” PSS candidates)

The PSS detection procedure detailed above may also be expressed as follows:

$$( I , J ) = {argmax}_{i , j} ( {\sum }_{n - 0}^{N - 1} {cor}_{n * U + i , j} ) , \qquad ( 1 )$$

where (I,J) are the set of input sample index-PSS sequence index (sector ID) pairs (i.e. “PSS candidates”) with “maximum” cross-correlation metrics composed of input sample time candidates (per half-frame) I and sector ID candidates J, N is the number of half-frames used for PSS detection (such as e.g. 2, 4, 5, etc.), U is the total number of correlation metrics per possible sector ID value within one half-frame (corresponding to the number of input samples per half-frame, e.g. 9600 for a 1.4 MHz system with base sampling rate of 1.92 MHz), iε[0, . . . , U−1] is the input sample index per half-frame, jε[0,1,2] is the sector ID index (PSS sequence index), and cor_{n+U+i,j} denotes the correlation between the [n+U+i]^{th} input sample (out of input sample indices [0, 1, . . . , NU−1] over N total half-frames) and PSS sequence PSSⱼ.

The cross-correlation value aggregation may be implemented in a number of alternate manners. For example, cross-correlation values for each PSS candidate may be first determined for multiple detection half-frames and subsequently summed after the detection half-frames are completed. In another example, cross-correlation values for each PSS candidate may be summed at the end of each detection half-frame, i.e. by using intermediately summed cross-correlation values for each PSS candidate. In a further example, cross-correlation values for each PSS candidate may be summed in “real-time”, i.e. by adding newly calculated cross-correlation values to the previously aggregated cross-correlation value for each PSS candidate as soon as each newly calculated cross-correlation value is available (e.g. as soon as the most recent input sample is processed).

The latter implementation may offer distinct memory requirement advantages over the former implementations, as determining the aggregated cross-correlation values in “real-time” may require only memory space correlated with the number of input samples in a single half-frame as opposed to the number of input samples in multiple half-frames (i.e. corresponding to calculating cross-correlation values for multiple half-frames prior to aggregation). However, even the latter “real-time” implementation may require substantial amounts of on-chip memory to hold intermediate cross-correlation value summations, as cross-correlation values for an entire half-frame may need to be stored in a buffer at any given time. Such memory requirements may be up to e.g. 40 KB. This memory requirement problem may be further magnified due to a typical requirement to support concurrent PSS detection procedures on multiple carriers (e.g. for cell search procedures) or for multiple Evolved Absolute Radio Frequency Channel Number (EARFCN) search (e.g. for Public Land Mobile Network (PLMN) search procedures). The memory requirements may thus be compounded by a factor equal to the number of desired parallel PSS detection procedures.

The memory space requirements of such PSS detection procedures are directly correlated to the high number of PSS candidates (i.e. input sample index-PSS sequence index pairs) per half-frame of data, which may be calculated as the number of input samples per half-frame (e.g. 9600 for a 1.4 MHz bandwidth LTE configuration) multiplied by the number of possible PSS sequences (e.g. 3 in an LTE configuration).

In order to reduce memory requirements, an improved PSS detection procedure may select “peak” PSS candidates (i.e. input sample index-PSS sequence index (sector ID) pairs) based on associated cross-correlation values to store in memory while discarding other “non-peak” PSS candidates. The identification of“peak” PSS candidates may be performed substantially in real-time, such as by evaluating each newly calculated cross-correlation value or group of newly calculated cross-correlation values in the same process. Accordingly, only cross-correlation values for PSS candidates that produce high cross-correlation values (“peak” cross-correlation values) will be stored in a buffer as peak PSS candidates, while cross-correlation values for other PSS candidates will not be stored. As the identification of peak PSS candidates may be performed substantially in real-time (or with a small delay of several input samples for in order to analyze several cross-correlation values from several input samples at once), only a subset of the PSS candidates (peak PSS candidates) may need to be stored in the buffer at any given time, thereby reducing memory requirements. A database of peak PSS candidates may be obtained for each detection half-frame and subsequently merged with peak PSS candidates from subsequent detection half-frames, thereby assisting in noise and interference mitigation. A final set of peak PSS candidates may be determined based on the merged peak PSS candidate sets from the detection half-frames, thereby producing a final set of peak PSS candidates as outputs of PSS detection.

Although a slight increase in computational logic may be required in order to perform peak PSS candidate identification, the resulting memory space reduction may reduce silicon area by up to 75-80%. The reduction in memory may also assist in overall power gain, as memory leakage power may be similarly reduced as a result of a decrease in overall memory space requirements.

The improved PSS detection procedure may be summarized as follows:
a) For each input sample per half-frame of received downlink data. calculate the cross-correlation with each of the three possible local PSS sequences (locally generated or stored) to generate a cross-correlation value for each input sample index-PSS sequence index (sector ID) pair (PSS candidate); and evaluate each cross-correlation (or set of cross-correlations), to determine whether to store the PSS candidate in the peak PSS candidate database (retain as a peak PSS candidate) or to discard the PSS candidate (discard as a non-peak PSS candidate)
b) Merge peak PSS candidate databases for multiple detection half-frames to generate peak PSS candidate database with aggregated cross-correlation values
c) Select peak PSS candidates with maximum aggregated cross-correlation values as the outputs of improved PSS detection

The improved PSS detection procedure detailed above may be expressed as follows (as compared to Equation 1 detailed above):

(I,J)=MS(argmax_{i,j}(cor_{n*u+i,j})) (2),

where MS represents merging and selecting of peak PSS candidates over multiple detection half-frames.

The merging and selection MS procedure may be utilized to combine peak PSS candidate databases (one database per detection half-frame) in order to “sharpen” peaks for “real” cells (as opposed to “false” cells characterized by erroneous detection of a peak cross-correlation value). While it is possible that downlink signal corruption (including noise and/or interference) may result in generation of a false cross-correlation peak for a given input sample in a given detection half-frame, it is unlikely that the same input sample will generate another cross-correlation peak in a subsequent detection half-frame (due to e.g. the time-varying properties of noise and/or interference). However, a real cell (i.e. proximate cells that remain observable over multiple detection half-frames) will likely produce a peak cross-correlation value at substantially the same input samples (i.e. input sample index within the detection half-frame) over multiple detection half-frames. Accordingly, if the same input sample (or substantially the same input sample, as will be later described) produces a peak cross-correlation value over multiple detection half-frames, the improved PSS detection procedure may “sharpen” this peak PSS candidate, thereby placing a higher priority on the peak PSS candidate for final peak PSS candidate selection.

There exist several implementations for sharpening peak PSS candidates that appear in peak PSS candidate databases in multiple detection half-frames. For example, a first peak PSS candidate database from a first detection half-frame may be compared to a second peak PSS candidate database from a second detection half-frame. If a peak PSS candidate of the first peak PSS candidate database matches with a peak PSS candidate of the second PSS candidate database (i.e. has the same sector ID and substantially equal input sample index), the UE may “combine” the peak PSS candidate of the first peak PSS candidate database with the peak PSS candidate of the second PSS candidate database by summing the cross-correlation values to produce a combined peak PSS candidate. The first peak PSS candidate database and second peak PSS candidate database may then be merged to produce a merged peak PSS candidate database, which may be subsequently sorted according to cross-correlation value (where the combined peak PSS candidate appears once in the merged database). The peak PSS candidates of the merged peak PSS candidate database with maximum cross-correlation values may then be retained, while the remaining peak PSS candidates may be discarded. As the combined peak PSS candidate has a summed cross-correlation value, the combined peak PSS candidate may have higher priority to be selected to be retained. It is appreciated that the combined peak PSS candidate may be derived in a variety of different manners from the two matching peak PSS candidates, such as by using a weighting factor as opposed to calculating a direct sum of the cross-correlation values.

The merging and selection MS procedure may not require that the input sample index of a first peak PSS candidate exactly matches the input sample index of a second peak PSS candidate from different peak PSS candidate databases in order to aggregate the first and second peak PSS candidates. For example, the merging and selection MS procedure may instead determine whether the input sample index of the first peak PSS candidate is substantially proximate to the input sample index of the second peak PSS candidate, i.e. within X input sample indices, where X equals positive integer such as any one of 1, 2, 3, 5, etc. However, the merging and selection MS procedure may require that the PSS sequence index of the first peak PSS candidate matches the PSS sequence index of the second peak PSS candidate in order to aggregate the first and second peak PSS candidates.

It is appreciated that the merging and selection MS procedure may be performed at several alternate points during the improved PSS detection procedure. For example, a UE may determine a peak PSS candidate database for each of the detection half-frames (while evaluating every sample or set of samples in each detection half-frame to determine which PSS candidates should be retained as part of the peak PSS candidate database for a given detection half-frame) and perform merging and selection after the detection half-frames have concluded.

Alternatively, a UE may perform merging and selection after a subset of the detection half-frames have concluded, such as by merging and selecting peak PSS candidate databases when a new peak PSS candidate is available from a recently concluded detection half-frame. Potential further memory savings associated with this approach may offset any increased performance requirements.

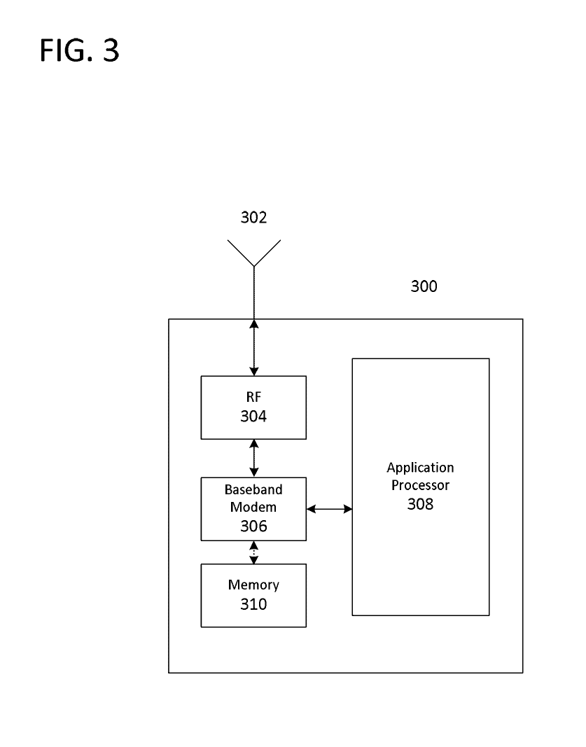

As previously detailed, the PSS detection procedures detailed herein may be implemented by a UE, such as UE 300 as shown in FIG. 3. As illustrated in FIG. 3, UE 300 may include antenna 302, radio frequency (RF) transceiver 304, baseband modem 306, application processor 308, and memory 310. The aforementioned components of UE 300 may be implemented as separate circuits, e.g. as separate integrated circuits, as illustrated in FIG. 3. While the aforementioned components of UE 300 are depicted separately in FIG. 3, it is appreciated that this architecture is merely for purposes of explanation, and accordingly one or more of the aforementioned components of UE 300 may be integrated into a single component, such as e.g. a common programmable processor or microprocessor, or may be separated into multiple distinct components. In an exemplary aspect of the disclosure, antenna 302 may be integrated as part of RF transceiver 304. In a further exemplary aspect of the disclosure, baseband modem 306 and application processor 308 may be integrated into a single component. Substantially all such variations are thus considered within the scope of this disclosure.

As will be detailed, in an aspect of the disclosure UE 300 may be a mobile terminal device having a radio processing circuit (RF transceiver 304) and a baseband processing circuit (baseband modem 306) adapted to interact with the radio processing circuit. UE 300 may be configured to calculate one or more correlation values, each of the correlation values representing the correlation between a digitally-sampled communication signal and a respective reference signal, apply a predefined criteria to the one or more correlation values in order to decide whether to exclude the one or more correlation values from a peak correlation database, the peak correlation database containing the remaining correlation values, and detect one or more transmitted reference signals within the digitally-sampled communication signal using the peak correlation database.

In a further aspect of the disclosure, UE 300 may be a mobile terminal device having a radio processing circuit (RF transceiver 304) and a baseband processing circuit (baseband modem 306) adapted to interact with the radio processing circuit. UE 300 may be configured to calculate a plurality of correlation values as candidates for a peak correlation database, each correlation value representing the correlation between a digitally-sampled communication signal and a respective reference signal, repeatedly update the peak correlation database by evaluating one or more of the plurality of correlation values in order to decide whether or not to store the one or more of the plurality of correlation values in the peak candidate database, and detect one or more transmitted reference signals within the digitally-sampled communication signal using the peak correlation database.

It is appreciated that the aforementioned components of UE 300 may be implemented in a number of different manners, such as by hardware, firmware, software executed on e.g. a processor, or a mixture of hardware and software. Various options include Application Specific Integrated Circuits (ASICs), Field Programmable Logic Arrays (FPGAs), Central Processing Units (CPUs), Graphics Processing Units (GPUs), Digital Signal Processors (DSPs), etc.

It is understood that UE 300 may have one or more additional components, such as additional hardware, software, or firmware elements. For example, UE 300 may further include various additional components including hardware, firmware, processors, microprocessors, memory, and other specialty or generic hardware/processors/circuits, etc., in order to support a variety of additional operations. UE 300 may also include a variety of user input/output devices (display(s), keypad(s), touchscreen(s), speaker(s), external button(s), camera(s), microphone(s), etc.), peripheral devices, memory, power supply, external device interfaces, etc.

UE 300 may be configured to receive and/or transmit wireless signals according to multiple different wireless access protocols, including any one of, or any combination of, LTE (Long Term Evolution), WLAN (wireless local area network), WiFi, UMTS (Universal Mobile Telecommunications System), GSM (Global System for Mobile Communications), Bluetooth, CDMA (Code Division Multiple Access), Wideband CDMA (W-CDMA), etc. It is appreciated that separate components may be provided for each distinct type of compatible wireless signals, such as a dedicated LTE antenna, RF transceiver, and baseband modem for LTE reception and transmission and a dedicated WiFi antenna, RF transceiver, and baseband modem for WiFI reception and transmission. Alternatively, one or more components of UE 300 may be shared between different wireless access protocols, such as e.g by sharing antenna 302 between multiple different wireless access protocols. In an exemplary aspect of disclosure, RF transceiver 304 and/or baseband modem 306 may be operate according to multiple mobile communication access protocols (i.e. “multi-mode”), and thus may be configured to support one or more of LTE, UMTS, and/or GSM access protocols.

RF transceiver 304 may thus receive RF wireless signals via antenna 302, which may be implemented as e.g. a single antenna or an antenna array composed of multiple antennas. RF transceiver 304 may include various reception circuitry elements configured to process externally received signals, such as mixing circuitry to convert externally received RF signals to baseband and/or intermediate frequencies. RF transceiver 304 may also include amplification circuitry to amplify externally received signals, such as power amplifiers (PAs) and/or Low Noise Amplifiers (LNAs), although it is appreciated that such components may also be implemented separately. RF transceiver 304 may additionally include various transmission circuitry elements configured to transmit internally received signals, such as e.g. baseband and/or intermediate frequency signals provided by baseband modem 306, which may include mixing circuitry to module internally received signals onto one or more radio frequency carrier waves and/or amplification circuitry to amplify internally received signals before transmission. RF transceiver 304 may provide such signals to antenna 302 for wireless transmission.

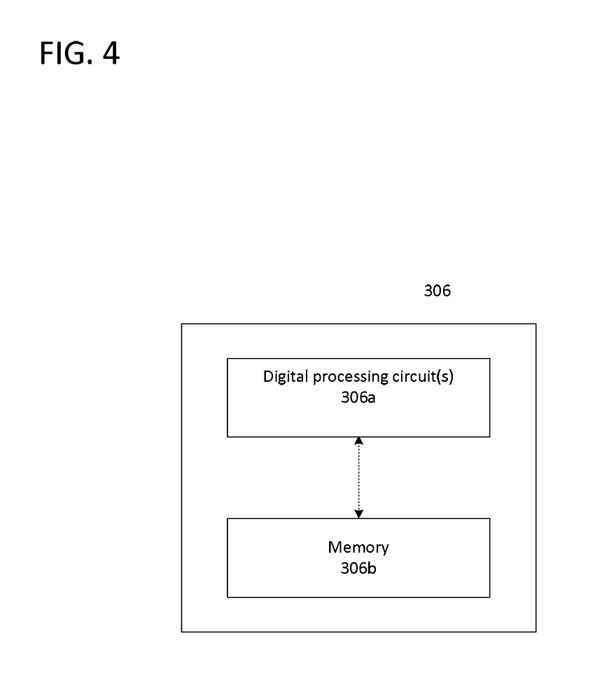

FIG. 4 shows a block diagram illustrating an internal configuration of baseband modem 306 according to an aspect of the disclosure. Baseband modem 306 may include digital processing circuit(s) 306a (i.e. one or more digital processing circuits) and baseband memory 306b, which may be e.g. memory 310 in an implementation where memory 310 is integral to baseband modem 306. Although not explicitly shown in FIG. 4, baseband modem 306 may contain one or more additional components, including one or more analog circuits.

Digital processing circuit(s) 306a may be composed of various processing circuitry configured to perform baseband (herein also including “intermediate”) frequency processing, such as Analog to Digital Converters (ADCs) and/or Digital to Analog Converters (DACs), modulation/demodulation circuitry, encoding/decoding circuitry, audio codec circuitry, digital signal processing circuitry, etc. Digital processing circuit(s) 306a may include hardware, software, or a combination of hardware and software. Specifically, digital processing circuit(s) 306a of baseband modem 306 may include one or more logic circuits, processors, microprocessors, Central Processing Units (CPU), Graphics Processing Units (GPU) (including General-Purpose Computing on GPU (GPGPU)), Digital Signal Processors (DSP), Field Programmable Gate Arrays (FPGA), integrated circuits, Application Specific Integrated Circuits (ASIC), etc., or any combination thereof. It is understood that a person of skill in the art will appreciate the corresponding structure disclosed herein, be it in explicit reference to a physical structure and/or in the form of mathematical formulas, prose, flow charts, or any other manner providing sufficient structure (such as e.g. regarding an algorithm). The components of baseband modem 306 may be detailed herein substantially in terms of functional operation in recognition that a person of skill in the art may readily appreciate the various possible structural realizations of baseband modem 306 using digital processing circuitry that will provide the desired functionality.

Baseband memory 306b may include volatile and/or non-volatile memory, including random access memory (RAM), read-only memory (ROM), flash memory, solid-state storage, magnetic tape, hard disk drive(s), optical drive(s), register(s), shift register(s), processor register(s), data buffer(s) etc., or any combination thereof. Baseband memory 306b may be configured to store software elements, which may be retrieved and executed using a processor component of digital processing circuitry 306a. Although depicted as a single component in FIG. 4, baseband memory 306b may be implemented as one or more separate components in baseband modem 306. Baseband memory 306b may also be partially or fully integrated with digital processing circuitry 306a.

Baseband modem 306 be configured to operate one or more protocol stacks, such as a GSM protocol stack, a UMTS protocol stack, an LTE protocol stack, etc. Digital processing circuitry 306a may therefore include a processor configured to execute program code in accordance with the protocol stacks of each associated RAT. Baseband memory 306a may be configured to store the aforementioned program code. Although not explicitly depicted in FIG. 4, baseband modem 306 may be configured to control one or more further components of UE 300, in particular one or more microphones and/or speakers, such as by providing output audio signals to one or more speakers and/or receiving input audio signals from one or more microphones.

The protocol stack(s) of baseband modem 306 may be configured to control operation of baseband modem 306, such as in order to transmit and receive mobile in accordance with the corresponding RAT(s).

As will be further detailed, baseband modem 306 may contain digital processing circuitry (digital processing circuit(s) 306a) and a memory (baseband memory 306b, which may be e.g. memory 310 in an aspect of the disclosure where memory 310 is an integrated component of baseband modem 306). Baseband modem 306 may be configured to calculate a plurality of correlation values as candidates for a peak correlation database, each correlation value representing the correlation between a digitally-sampled communication signal and a respective reference signal, repeatedly update the peak correlation database by evaluating one or more of the plurality of correlation values in order to decide whether or not to store the one or more of the plurality of correlation values in the peak candidate database, and detect one or more transmitted reference signals within the digitally-sampled communication signal using the peak correlation database.

Application processor 308 may be implemented as a Central Processing Unit (CPU), and may function as a controller for UE 300. Application processor 308 may be configured to execute various applications and/or programs of UE 300, such as e.g. applications corresponding to program code stored in a memory component of UE 300. Application processor 308 may also be configured to control one or more further components of UE 300, such as user input/output devices such as displays, keypads, touchscreens, speakers, external buttons, cameras, microphones, etc.

As previously indicated, UE 300 may include one or more memory components, which may be physically located at various locations within UE 300. In an exemplary aspect of the disclosure, one or more components of UE 300 may have access to memory components of UE 300, which may be shared or dedicated. As shown in FIG. 3, UE 300 may be provided with memory 310. Although memory 310 is shown as a separate component, it is appreciated that memory 310 may be integrated into baseband modem 306, e.g. on a common chip.

In an advantageous aspect of the disclosure, memory 310 may be in integral with baseband modem 306. Baseband modem 306 may thus utilize memory 310 to support a variety of operations. Specifically, baseband modem 306 may utilize memory 310 to implement a buffer during PSS detection, and may store PSS detection results as a database in a buffer within memory 310.

In an exemplary aspect of the disclosure, antenna 302, RF transceiver 304, and baseband modem 306 may be configured to support at least LTE reception and transmission. As previously detailed above regarding PSS detection procedures, a UE may receive a downlink signal composed of downlink transmission from one or more proximate cells. Corresponding to UE 300, UE 300 may receive a downlink signal in the form of a wireless RF signal at antenna 302, which may be initially processed by RF transceiver 304 to produce a resulting baseband (or e.g. intermediate) frequency signal. RF transceiver 304 may then provide the resulting baseband signal to baseband modem 306. Baseband modem 306 may then perform various processing operations on the received baseband signal, such as the PSS detection procedures detailed above.

In order to reduce memory requirements of memory 310, baseband modem 306 may implement the improved PSS detection procedure associated with Equation 2 detailed above, which may reduce memory requirements by storing peak PSS candidates in the peak PSS candidate database (i.e. in a buffer) within memory 310 during each detection half-frame while discarding other peak PSS candidates. Baseband modem 306 may decide whether to retain or discard PSS candidates in the peak PSS candidate database based on the cross-correlation value associated with each PSS candidate. Baseband modem 306 may also merge and select peak PSS candidate databases from multiple detection half-frames in order to further reduce memory requirements.

By deciding to retain peak PSS candidates within memory 310 and discarding other PSS candidates, the silicon area for memory 310 may be reduced. In and advantageous aspect of the disclosure in which memory 310 and baseband modem 306 are included on a single integrated chip, the silicon area for the common integrated chip may thus be reduced.

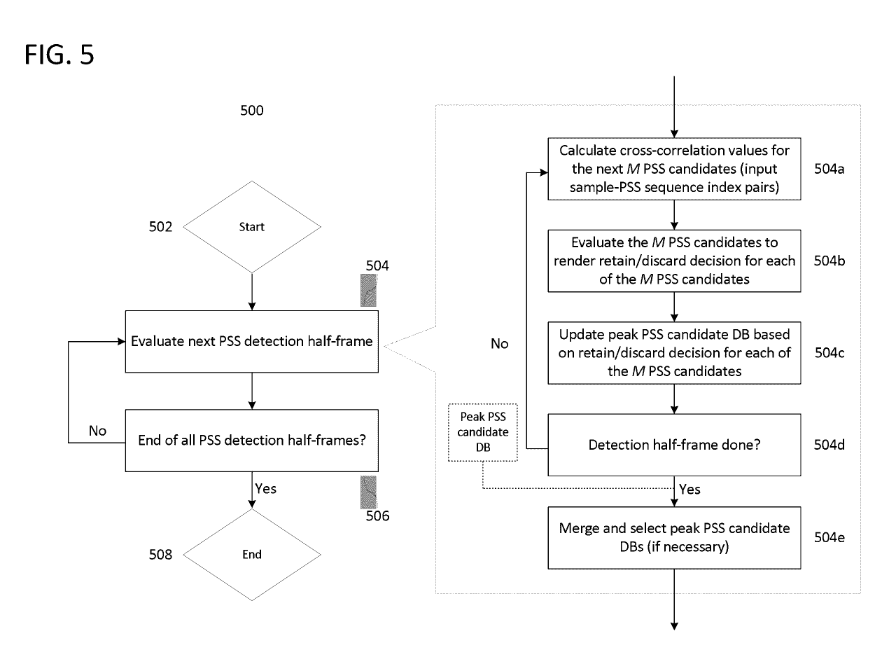

FIG. 5 shows two flow charts illustrating method 500 for performing PSS detection according to an exemplary aspect of the disclosure. Method 500 is considered to be substantially similar to the improved PSS detection procedure detailed above, and thus may be executed by a broadband/modem processing component of a UE such as broadband modem 306 of UE 300 in order to reduce memory requirements and improve overall power gain during PSS detection.

Method 500 may initialize the improved PSS detection procedure in 502. 502 may include receiving and processing a received wireless RF signal (such as by antenna 302 and RF transceiver 304) to generate a resulting baseband (or intermediate frequency) signal. The resulting baseband signal may then be provided to baseband modem 306, which may perform initial processing on the baseband signal including sampling (e.g. digitalization) in order to obtain a digital signal composed of multiple input samples. It is appreciated that method 500 may be substantially performed in real-time, and accordingly may utilize a substantially continuous stream of digital baseband input samples corresponding to the initially received downlink signal. The digital input sample stream may then be allocated into one or more 5 ms detection half-frames, where each input sample corresponds to an input sample index within a detection half-frame. Method 500 may then evaluate the next detection half-frame of the digital downlink signal in 504, i.e. may perform PSS detection using the input samples of the first detection half-frame (i.e. 5 ms of input samples, where the quantity of input samples may be dependent on the sampling rate). As PSS sequences are considered largely periodic, the initial starting point of the detection half-frame may be arbitrarily chosen. The remaining detection half-frames, as utilized later in method 500, may be the subsequently following 5 ms periods.

504 may include at least 504a-504e. As previously detailed, memory requirements may be reduced by retaining only certain PSS candidates in the peak PSS candidate database within memory 310 during each detection half-frame, thereby reducing the amount of data to be stored in a buffer as peak PSS candidates at a time. Memory requirements for memory 310 may also be reduced by merging and selecting peak PSS candidate databases (i.e. the MS procedure as detailed above regarding Equation 2) from multiple detection half-frames. It is appreciated that the execution of 504a-504e may be consistent with the process of Equation 2.

In 504a, method 500 may calculate cross-correlation values for the next M PSS candidates (i.e. input sample index-PSS sequence index (sector ID) pairs). M may be selected as a positive integer, and may determine the number of PSS candidates that are evaluated by 504 at a time. As will be later described, further processing efficiency may be achieved by applying a Batcher network based on the selection of M. However, it is understood that M may also simply be selected as a positive integer to denote the quantity of PSS candidates evaluated for retain/discard at a given time.

504a may therefore generate a cross-correlation value for each of the next M PSS candidates. Each of the M PSS candidates may be an input sample (identified by input sample index within a detection half-frame) and PSS sequence index. 504a may thus calculate the cross-correlation between the input sample and the PSS sequence corresponding to the PSS sequence index of each of the M PSS candidates. As previously discussed, each of the three PSS sequences PSS₀, PSS₁, and PSS₂ are predefined as sequences of 62-complex symbols of a Zadoff-Chu sequence, where each PSS sequence utilizes a different root for the Zadoff-Chu sequence. 504a may utilize locally generated or stored PSS sequences in order to calculate the connected cross-correlation values. 504a may calculate the cross-correlation in the time or the frequency domain, e.g. by utilizing locally stored/generated time-domain PSS sequences or the corresponding frequency domain-PSS sequences. It is appreciated that further processing on the input signal samples may be required for frequency-domain cross-correlation calculations, such as a Fast Fourier Transform (FFT).

As PSS sequences exhibit essentially zero autocorrelation for all non-zero lags, the cross-correlation values for the input sample located at the beginning of a PSS sequence within the downlink signal may exhibit substantially greater cross-correlation with the local PSS sequence than other input samples. As the PSS sequences PSS₀, PSS₁, and PSS₂ are largely uncorrelated with one another, only a matching local PSS sequence may produce a high cross-correlation value with an input sample. Accordingly, input sample index-PSS sequence index pairs producing high cross-correlation values may be interpreted as representing an input sample occurring at the beginning of the PSS sequence within a received downlink signal.

504a may therefore calculate cross-correlation values for the next M PSS candidates. 504b may then evaluate the obtained M PSS candidates in order to decide whether to retain (within the peak PSS candidate database of memory 310) or discard each of the M PSS candidates, such as by evaluating the cross-correlation value of each of the M PSS candidates. 504c may then apply the retain/discard decision of 504b for each of the M PSS candidates in order to update the peak PSS candidate database for the current detection half-frame. For example, 504c may retain only PSS candidates that were selected to be retained in 504b, i.e. may only include PSS candidates selected to be retained in the peak PSS candidate database in memory 310 for the current detection half-frame. The remaining PSS candidates may not be stored in the peak PSS candidate database for the current detection half-frame, and thus may be discarded. The capacity requirement of memory 310 may thus be reduced, thereby reducing silicon area of memory 310.

The parameter M thus serves to limit the number of PSS candidates that are evaluated for retain/discard at one time, and additionally limits the maximum number of PSS candidates within the peak PSS candidate database that may be modified/updated at a time. As will be later detailed, M may be selected to correspond with a minimum-valued PSS candidate database for processing efficiency enhancements.

504c may thus produce an updated peak PSS candidate database for the current detection half-frame. As previously detailed, the peak PSS candidate database may include only PSS candidates selected to be retained based the associated on cross-correlation value in 504b. Accordingly, upon execution by a baseband modem such as baseband modem 306, method 500 may have significantly reduced memory requirements due to the reduced number of PSS candidates for which data is retained in the buffer, which may reduce the required capacity of on-chip memory when memory 310 is integral with baseband modem 306. Baseband modem 306 may thus only require memory to store detection data (cross-correlation value, input sample index, and PSS sequence index (sector ID) for PSS candidates retained in the peak PSS candidate database. The amount of memory required may thus depend on the number of PSS candidates retained in the PSS candidate database for each detection half-frame, which may be determined by the approach utilized to evaluate PSS candidates in 504b (as will be later detailed). The amount of memory required for memory 310 may also be dependent on the type of merging and selection utilized in 504e, such as e.g. how often the merging and selection is performed (as PSS detection for each pending detection half-frame may need to be stored until the pending detection half-frames are merged).

504d may then determine if the current detection half-frame has concluded. If the current detection half-frame has not concluded, method 500 may return to 504a to calculate cross-correlation values for the next M PSS candidates, and subsequently repeat 504b-504d. If the current detection half-frame has concluded, method 500 may proceed to 504e, which may merge and select the peak PSS candidates database of the current detection half-frame (if necessary) with one or more peak PSS candidate databases from previous detection half-frames. For example, 504e may execute the merging and selection MS procedure detailed above regarding Equation 2. For example, 504e may identify PSS candidates from multiple peak PSS candidate lists having matching PSS sequence indices and substantially equal input sample indices. 504e may then aggregate any matching PSS candidates by summing the cross-correlation values. 504e may then merge the peak PSS candidate lists into a single list including aggregated cross-correlation values for any matching peak PSS candidates. Broadband modem 306 may therefore save further memory while placing emphasis on any matching PSS candidates.

Method 500 may then proceed to 506, as previously detailed. After all half-frames utilized for PSS detection have concluded, method 500 may terminate at 508. The updated peak PSS candidate database stored in memory 310 may thus serve as the outputs of PSS detection, and may include only the PSS candidates with peak cross-correlation values. Baseband modem 306 may then utilize the time sample index-PSS sequence index pair associated with each peak PSS candidate in order to proceed with synchronization and cell identification operations, such as SSS detection to obtain frame synchronization and PCI of each detected cell.

It is appreciated that any number of half-frames may be utilized as detection half-frames, such as e.g. 1, 2, 4, 5, etc. Larger quantities of detection half-frames may be more robust against noise and interference, but inherently may require increased overall PSS detection time.

In an exemplary aspect of the disclosure, M may be selected as e.g. M=1, resulting in method 500 performing evaluation of one PSS candidate at a time in 504b. 504a may thus produce a single PSS candidate (input sample index-PSS sequence index pair) by calculating the cross-correlation between a single input sample and one of the three possible PSS sequences PSS₀, PSS₁, or PSS₂. 504b may then evaluate the resulting PSS candidate by analyzing the cross-correlation value associated with the PSS candidate, which will be later described in further detail. If 504b decides to retain the PSS candidate, 504c may store the PSS candidate in the peak PSS candidate database for the current detection half-frame. If 504c decides not to retain the PSS candidate (i.e. to discard the PSS candidate), 504c may not store the PSS candidate in the peak PSS candidate database for the current detection half-frame. Method 500 may therefore reduce memory requirements as compared to PSS detection associated with Equation 1, which may require that data for all PSS candidates in a detection half-frame be stored (or included in intermediate sum values).

In another exemplary aspect of the disclosure, M may be selected as e.g. M=3. 504a may thus produce three PSS candidates, which 504b may subsequently evaluate. This evaluation may be done using e.g. batch networking, as will be later detailed, which may optimize the PSS candidate evaluation process. 504b may thus determine to retain or discard the each of the three PSS candidates. 504c may then update the peak PSS candidate database to retain only the PSS candidates selected to be retained in 504b. The remaining PSS candidates may be discarded.

The selection of M=3 may allow for the PSS candidates associated with each input sample (e.g. the PSS candidates with cross-correlations resulting from comparing a single input sample to each of the three possible PSS sequences) to be evaluated at one time. Similarly, selecting M=6 may allow for the PSS candidates associated with two consecutive input samples to be evaluated at one time. Alternatively, the selection of M=3 may allow for PSS candidates associated with three consecutive input samples and the same PSS sequence to be evaluated at a time. Alternatively, 504a-504b may be parallelized, such as into three concurrent streams, where each parallel stream operates on PSS candidates associated with a respective PSS sequence. It is appreciated that these evaluation orderings are exemplary, and accordingly PSS candidates may be evaluated by 504b in essentially any order.

There exist severable possible implementations for the evaluation and update procedures of 504b and 504c, which may impact memory requirements of memory 310. Broadband modem 306 may implement PSS candidate database as a buffer in memory 310, and thus may store PSS detection data (cross-correlation value, input sample index, PSS sequence index (sector ID)) for each PSS candidate in the buffer. In an exemplary aspect of the disclosure, the capacity of the PSS candidate database for each detection half-frame may be limited to a predefined quantity, such as e.g. 100 PSS candidates. Accordingly, only 100 PSS candidates may be stored in the PSS candidate database for each detection half-frame at a time. 504b may thus evaluate the M PSS candidates by determining which, if any, of the M PSS candidates have cross-correlation values that exceed at least one of the 100 PSS candidates currently held in the PSS candidate database. 504b may thus decide to retain only the PSS candidates of the M PSS candidates that have cross-correlation values in the top 100 in the peak PSS candidate database. 504c may then update the peak PSS candidate database to include the PSS candidates of the M PSS candidates (if any) by replacing the PSS candidates of the PSS candidate database with minimum values, while discarding the remaining PSS candidates of the M PSS candidates. 504c may thus produce a peak PSS candidate database with 100 peak PSS candidates. For example, 504c may rank the PSS candidates in the peak PSS candidate database along with the M PSS candidates, and select the 100 PSS candidates that have the highest cross-correlation values. 504c may then update the peak PSS candidate database to include these 100 PSS candidates, and may discard the remaining PSS candidates. 504c may perform this update by performing a full ranking of each all of the PSS candidates. Alternatively, as will be later described, broadband modem 306 may utilize a minimum cross-correlation database to perform updates of the peak PSS candidate database.

The buffer size required by method 500 within memory 310 may thus be substantially static. It is appreciated that the size of the peak PSS candidate database may be selected to be any positive integer value bounded by the total number of possible PSS candidates per detection half-frame, such as e.g. 10, 20, 50, 100, 150, etc. It is appreciated that selections of larger capacities for the peak PSS candidate database will result in increased memory requirements for memory 310, while selection of significantly small capacities may increase the likelihood that one or more PSS candidates corresponding to real cells will be falsely discarded.

In the above-detailed implementation, the peak PSS candidate database (i.e. buffer within memory 310) may simply be filled with the first 100 obtained PSS candidates before any cross-correlation comparisons between PSS candidates are performed. Method 500 may therefore be modified to include a procedure to determine whether the peak PSS candidate database is full. Each of the M PSS candidates from 504a may thus be retained in the peak PSS candidate database if the peak PSS candidate database is not full and has sufficient capacity for each of the M peak PSS candidates. If the peak PSS candidate database is full (or does not have sufficient capacity for each of the M peak PSS candidates, 504b may execute a cross-correlation comparison as detailed above to determine the top 100 peak PSS candidates from the current peak PSS candidate database and the M PSS candidates.

In an alternate aspect of the disclosure, 504b may evaluate the M PSS candidates by comparing the cross-correlation values of the M PSS candidates to a cross-correlation threshold, and only retaining the PSS candidates of the M PSS candidates having a cross-correlation value that exceeds the cross-correlation threshold. Accordingly, only PSS candidates having sufficiently high cross-correlation values may be retained in the PSS peak candidate database. However, such an approach may require a dynamic buffer and may not be able to rely on static buffer size.

Many additional such variations are possible. For example, 504b utilize a fixed peak PSS candidate database size in combination with an initial threshold cross-correlation comparison. If the peak PSS candidate database is not full and has sufficient capacity, 504b may select PSS candidates of the M PSS candidates having cross-correlations that satisfy a cross-correlation threshold to be retained. Similarly, if the peak PSS candidate database is full or does not have sufficient capacity, 504b may first determine if any of the M PSS candidates has a cross-correlation value satisfying the cross-correlation value threshold before initializing any comparison to update the peak PSS candidate database.

Alternatively, 504b may simply select the PSS candidate of the M PSS candidates with the highest cross-correlation to be retained in the peak PSS candidate database. While this selection operation may offer simplicity, it may result in a higher likelihood that one or more PSS candidates corresponding to a real cell will be falsely discarded.

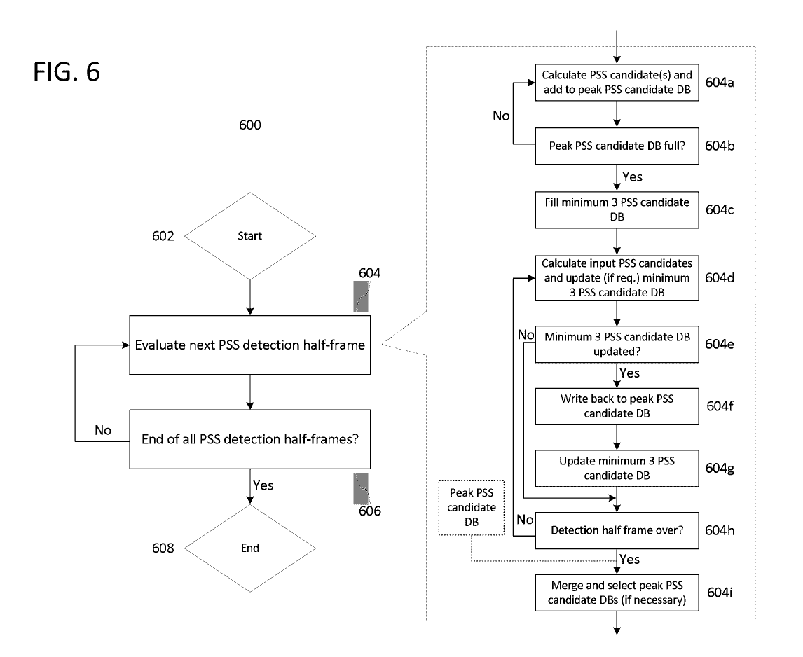

FIG. 6 shows a flow chart illustrating method 600 for performing PSS detection according to a further exemplary aspect of the disclosure. Method 600 may be executed within a UE such as UE 300, such as by broadband modem 306. As opposed to the full ranking of PSS candidates in 504c of method 500, method 600 may instead utilize a minimum PSS candidate database to update the peak PSS candidate database during a detection half-frame. The minimum PSS candidate database may store the PSS candidates of the peak PSS candidate database that have minimum (i.e. the smallest) cross-correlation values. In the exemplary implementation detailed in FIG. 6, the minimum PSS candidate database may store the three PSS candidates of the peak PSS candidate database that have the smallest cross-correlation values. While the following description may include where the peak PSS candidate database and minimum PSS candidate database are both implemented using memory 310, it is appreciated that the peak PSS candidate database and minimum PSS candidate database may be implemented in separate memories.

Method 600 may begin in 602, which may include substantially the same functionality of 502 in method 500. 602 may therefore obtain a digitized downlink signal in the form of a stream of input samples. As detailed regarding method 500, method 600 may be performed substantially in real-time, and may thus process input samples of the digitized downlink signal as the input samples become available.

604 may evaluate the next detection half-frame, which may include analyzing each input sample of the next detection half-frame in 604a-604i. Similarly as detailed regarding 504 of method 500, 604a-604i may calculate the cross-correlation between each input sample of a given detection half-frame and each possible PSS sequence (locally generated or stored) to produce PSS candidates for the detection half-frame. The cross-correlation value of each PSS candidate may indicate the likelihood/reliability that the PSS candidate (input sample index and PSS sequence index) represents a real cell, i.e. a proximate detectable cell.

Method 600 may utilize a peak PSS candidate database in memory 310 having static size for each detection half-frame, such as e.g. having capacity for 100 PSS candidates. It is appreciated that other capacities may alternatively be utilized. 604a may calculate PSS candidate(s) and add the PSS candidate(s) to the peak PSS candidate database. 604a may therefore calculate one or more PSS candidates by calculating the cross-correlation between an input sample and one of the possible PSS sequences and add the resulting one or more PSS candidates to the peak PSS candidate database in memory 310. 604b may then determine whether the peak PSS candidate database is full. 604a may continue to calculate PSS candidates and add the resulting PSS candidates to the peak PSS candidate database until 604b determines that the peak PSS candidate database is full.

Once the peak PSS candidate database is full, 604c may identify the PSS candidates of the peak PSS candidate database having the smallest cross-correlation values and store the three PSS candidates with minimum cross-correlation values in a minimum PSS candidate database in memory 310. The PSS candidates in the minimum PSS candidate database may thus also be contained in the peak PSS candidate database. It is appreciated that other sizes/capacities of the minimum PSS candidate database may alternatively be selected. The peak PSS candidate database and minimum PSS candidate database may both be implemented in memory of broadband modem 306 as buffers.

604d may then calculate the next PSS candidates and compare these input PSS candidates to the PSS candidates in the minimum PSS candidate database in memory 310, i.e. to the three PSS candidates stored in the minimum PSS candidate database. 604d may then determine if any of the input PSS candidates have cross-correlation values that are greater than any of the cross-correlation values of the PSS candidates stored in the minimum PSS candidate database. 604d may update the minimum PSS candidate database by replacing any PSS candidates originally in the minimum PSS candidate database with any input PSS candidates that have greater cross-correlation values. Input PSS candidates that do not have cross-correlation values greater than at least one of the cross-correlation values of the PSS candidates in the minimum PSS candidate database will therefore not be stored, and will thus be discarded. Consequently, broadband modem 306 may have reduced memory requirements.

604e may then determine if the minimum PSS candidate database was updated. If the minimum PSS candidate database was not updated, i.e. none of the input PSS candidates were found to have greater cross-correlation values than any of the PSS candidates in the minimum PSS candidate database, 604 may proceed to 604h, as no further updates of the minimum PSS candidate database or peak PSS candidate database are required. If the minimum PSS candidate database was updated, i.e. at least one of the input PSS candidates was found to have a greater cross-correlation value than a PSS candidate in the minimum PSS candidate database, further updates to the peak PSS candidate database in memory 310 to replace may be required. 604f may therefore write back the PSS candidates in the minimum PSS candidate database to the peak PSS candidate database, thereby replacing PSS candidates previously stored in the minimum PSS candidate database with input PSS candidates having greater cross-correlation values in the peak PSS candidate database. 604f may thus update the peak PSS candidate database to reflect the input PSS candidates having sufficient cross-correlation values.

604g may then update the minimum PSS candidate database based on the updated peak PSS candidate database. 604g may therefore identify the three PSS candidates in the peak PSS candidate database having minimum cross-correlation values and additionally store these PSS candidates in the minimum PSS candidate database.

604h may then determine if the detection half-frame is over. If the detection half-frame is over, 604 may return to 604d to calculate the next PSS candidates and perform any database updates as previously detailed n 604d-604g. If the detection half-frame is over, the current peak PSS candidate database in memory 310 is the final peak PSS candidate database for the current half-frame, i.e. the PSS candidates having the highest cross-correlation values. These PSS candidates may thus represent the PSS candidates having the highest likelihood/probability of indicating a PSS sequence within the received downlink signal.

As 604 has only stored the PSS candidates having maximum cross-correlation values in the peak PSS candidate database, memory 310 may have reduced memory requirements compared to a conventional PSS detection procedure. Broadband modem 306 may conserve on-chip silicon area in an aspect of the disclosure where memory 310 and baseband modem 306 are integrated onto a single chip. Additionally, as the PSS candidates in the peak PSS candidate database have maximum-valued cross-correlation metrics, 604 may also obtain the PSS candidates having the highest likelihood/probability of indicating a PSS sequence within the received downlink signal.

604i may then merge and select the obtained peak PSS candidate database with one or more previously obtained peak PSS candidate databases from previous detection half-frames, such as by executing the merging and selection MS procedure detailed above regarding Equation 2. For example, 604i may identify PSS candidates from multiple peak PSS candidate lists having matching PSS sequence indices and substantially equal input sample indices. 604i may then aggregate any matching PSS candidates by summing the cross-correlation values. 604i may then merge the peak PSS candidate lists into a single list including aggregated cross-correlation values for any matching peak PSS candidates. Broadband modem 306 may therefore save further memory while placing emphasis on any matching PSS candidates.

As previously detailed, there may be several alternative approaches for suitable times to perform merging and selection, such as after all detection half-frames have concluded, after each detection half-frame, after every several detection half-frames, substantially in real-time, etc.

Method 600 may then proceed to 606 to determine whether all detection half-frames have concluded. If PSS detection frames are remaining, method 600 may return to 604 to evaluate the next detection half-frame. If all detection half-frames have concluded, method 600 may conclude at 608.

608 may thus result in a final peak PSS candidate database in memory 310, which may be derived by merging and selecting peak PSS candidate databases from multiple detection half-frames. The final peak PSS candidate database may therefore include PSS candidates having the highest cross-correlation metrics, which may be summed cross-correlation metrics in the event of matching PSS candidates from multiple detection half-frames. The PSS candidates in the final peak PSS candidate database may then be utilized as the outputs of PSS detection. The input sample index and PSS sequence index may thus represent the potential location of a specific PSS sequence in time within the received downlink signal, thereby corresponding to a real cell.

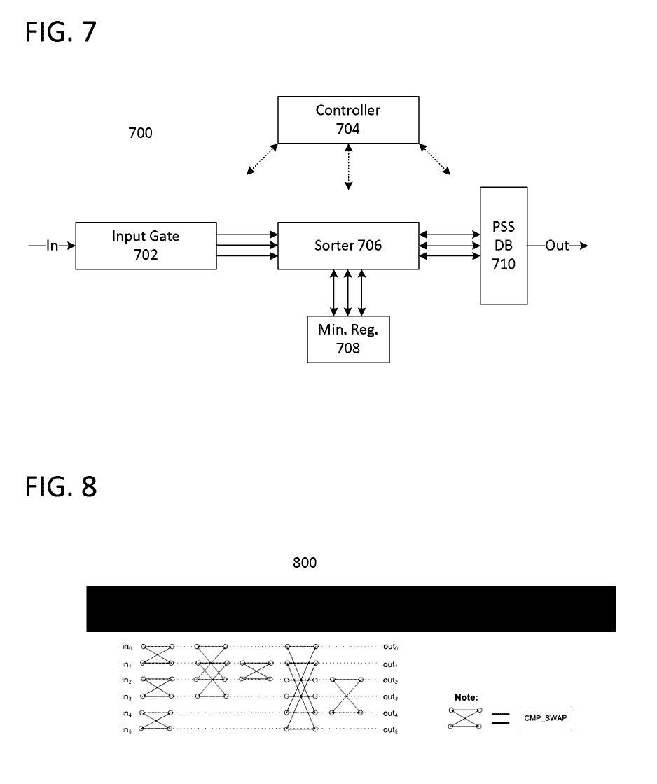

FIG. 7 shows block diagram 700 further illustrating components to perform improved PSS detection according to method 600. Block diagram 700 may be implemented as part of broadband modem 306, such as hardware components. Alternatively, block diagram 700 may be executed as software on a processing component of broadband modem 306 such as e.g. a microprocessor. Peak PSS candidate database 710 and minimum register 708 may be implemented using memory 310.

Input gate 702 may receive input samples, such as digitized input samples of a downlink signal received by UE 300. Input gate 702 may then produce input PSS candidates as outputs, such as three PSS candidates as outputs shown in FIG. 7. For example, input gate 702 may calculate the cross-correlation between each received input sample and each of the PSS sequences to produce the PSS candidates. Input gate 702 may provide e.g. three such PSS candidates at a time to sorter 706.

Sorter 706 may receive the input PSS candidates. Sorter 706 may be configured according to the modified Batcher network for minimum search as illustrated in FIG. 8. Sorter 706 may therefore utilize a compare and swap operation in order to identify the PSS candidates that have minimum cross-correlations, such as e.g. the three PSS candidates having the smallest cross-correlation values.

Sorter 706 may therefore perform a minimum search, and may provide the PSS candidates with minimum cross-correlation values to minimum register 708. Minimum register 708 may be a bank of three registers holding the three PSS candidates with the smallest cross-correlation values. Sorter 706 may also be configured to provide PSS candidates to peak PSS candidate database 710, which may be a buffer configured to hold a static number of PSS candidates, i.e. the PSS candidates having the highest cross-correlation values. Peak PSS candidate database 710 may be implemented as a ping-pong buffer in memory 310 to hold the peak PSS candidate list. Peak PSS candidate database 710 may hold the updated peak PSS candidate database during each detection half-frame and provide the final peak PSS candidate database for each detection half-frame.

Controller 704 may be configured to control the components of block diagram 700. For example, controller 704 may control the components of block diagram 700 by executing the state machine associated with method 600 to control the flow of data between the components of block diagram 700.

The implementations detailed herein thus provide an improved PSS detection procedure, which may reduce memory requirements and improve overall power gain by selectively retaining and discarding PSS candidates. Each PSS candidate may indicate the potential timing location of a specific PSS sequence corresponding to a proximate cell within a received downlink signal. The PSS candidates may be obtained based on the cross-correlation between input samples and locally generated or stored PSS sequences over one or more detection half-frames, and may be subsequently evaluated to be retained or discarded based on the associated cross-correlation values. PSS candidates having high cross-correlation values may indicate the presence of a PSS sequence of the corresponding PSS sequence index at the corresponding input sample of the PSS candidate. PSS detection outputs may therefore be a set of peak PSS candidates exhibiting high cross-correlation. The set of peak PSS candidates may then serve as the basis for further synchronization procedures, such as frame synchronization and PCI derivation based on SSS detection. Time synchronization tracking may then be performed based on CRS configurations for each detected cell derived from the associated PCI. PSS detection may therefore serve as an initial step in cell detection and timing synchronization, and may exhibit a strong influence on any further communications with detected cells.

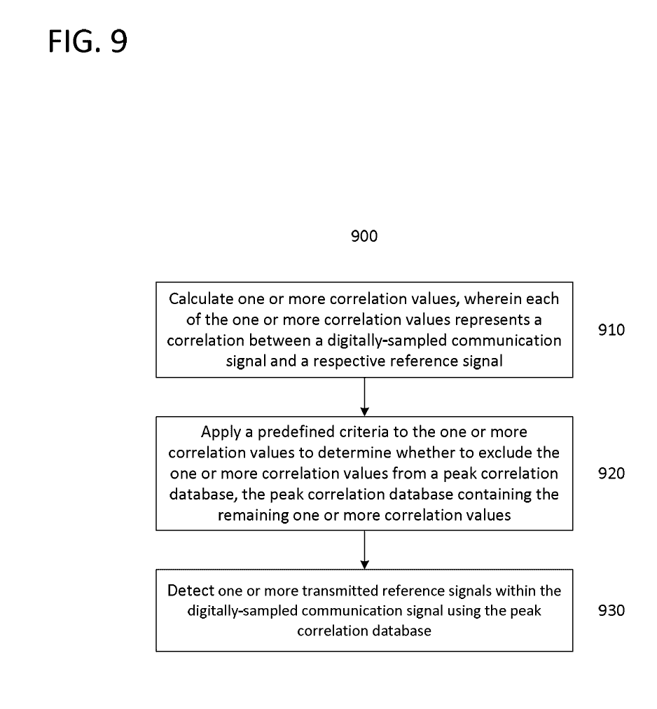

FIG. 9 shows a flow chart illustrating method 900 of detecting reference signals. Method 900 may implement the improved PSS detection procedures as detailed above, although it is appreciated that method 900 may be applied to detection of substantially any reference signal and is thus not limited to PSS detection.

In 910, method 900 may calculate one or more correlation values, each of the correlation values representing the correlation between a digitally-sampled communication signal and a respective reference signal. Method 900 may then apply a predefined criteria to the one or more correlation values in order to decide whether to exclude the one or more correlation values from a peak correlation database, the peak correlation database containing the remaining correlation values in 920. In 930, method 900 may detect one or more transmitted reference signals within the digitally-sampled communication signal using the peak correlation database.

The further features described above in reference to the improved PSS detection procedure, in particular regarding UE 300 and e.g. in each of FIGS. 1-8, are equally applicable with respect to method 900.

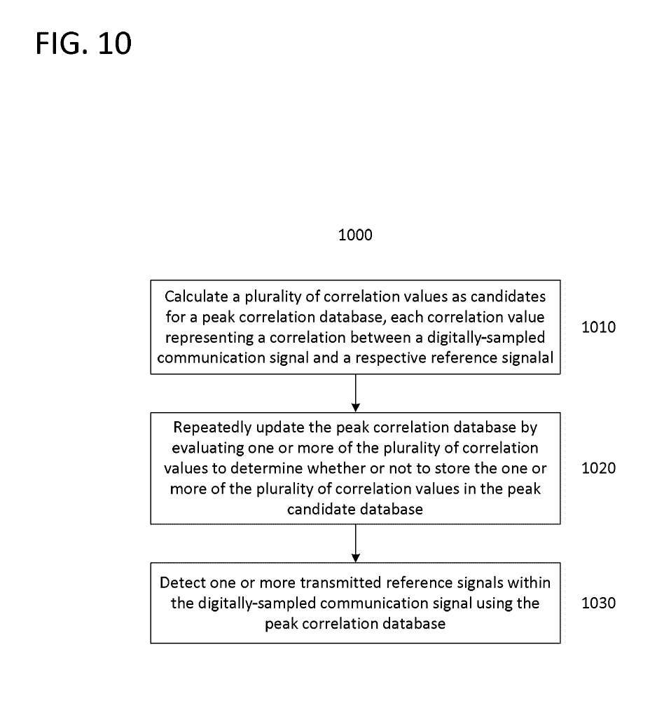

FIG. 10 shows a flow chart illustrating method 1000 of detecting reference signals. Method 1000 may implement the improved PSS detection procedures as detailed above, although it is appreciated that method 1000 may be applied to detection of substantially any reference signal and is thus not limited to PSS detection.

Method 1000 may in 1010 calculate one or more correlation values as candidates for a peak correlation database, each correlation value representing the correlation between a digitally-sampled communication signal and a respective reference signal. In 1020, method 1000 may repeatedly update the peak correlation database by evaluating one or more of the plurality of correlation values in order to decide whether or not to store the one or more of the plurality of correlation values in the peak candidate database. Method 1000 may then detect one or more transmitted reference signals within the digitally-sampled communication signal using the peak correlation database in 1030.

The further features described above in reference to the improved PSS detection procedure, in particular regarding UE 300 and e.g. in each of FIGS. 1-8, are equally applicable with respect to method 1000.

It is appreciated that the procedures detailed herein may be executed on a broadband modem component of a device, such as a cell phone. The broadband modem component may be further controlled by a controller, such as a core processor executing a protocol stack.

It is appreciated that implementations of methods detailed herein are considered demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include a one or more components configured to perform each aspect of the related method.

The following examples pertain to further aspects of this disclosure:

Example 1 is a method of detecting reference signals. The method includes calculating one or more correlation values, wherein each of the one or more correlation values represents a correlation between a digitally-sampled communication signal and a respective reference signal, applying a predefined criteria to the one or more correlation values to determine whether to exclude the one or more correlation values from a peak correlation database, the peak correlation database containing the remaining one or more correlation values, and detecting one or more transmitted reference signals within the digitally-sampled communication signal using the peak correlation database.

In Example 2, the subject matter of Example 1 can optionally include wherein the applying a predefined criteria to the one or more correlation values to determine whether to exclude the one or more correlation values from a peak correlation database includes comparing the one or more correlation values to a plurality of correlation values in the peak correlation database.

In Example 3, the subject matter of Example 1 can optionally include wherein the applying a predefined criteria to the one or more correlation values to determine whether to exclude the one or more correlation values from a peak correlation database includes ranking the one or more correlation values against a plurality of correlation values of the peak correlation database to identify one or more maximum-valued correlation values, and retaining the one or more maximum-valued correlation values in the peak correlation database.

In Example 4, the subject matter of any one of Examples 1 to 3 can optionally include wherein the calculating one or more correlation values includes calculating the cross-correlation between digital samples of the digitally-sampled communication signal and each of a plurality of reference signals to generate the one or more correlation values.

In Example 5, the subject matter of Example 4 can optionally include wherein the plurality of reference signals are predefined synchronization sequences.

In Example 6, the subject matter of Example 5 can optionally include wherein the plurality of reference signals are Primary Synchronization Signals (PSSs).

In Example 7, the subject matter of any one of Examples 1 to 6 can optionally include wherein the detecting one or more transmitted reference signals within the digitally-sampled communication signal using the peak correlation database includes identifying a digital sample of the digitally-sampled communication signal and a reference signal identifier associated with each correlation value of the peak correlation database.

In Example 8, the subject matter of Example 7 can optionally further include obtaining timing synchronization and identification information with a network cell based on the digital samples and reference signal identifiers associated with each correlation value of the peak correlation database.

In Example 9, the subject matter of any one of Examples 1 to 8 can optionally include wherein a digital sample of the digitally-sampled communication signal associated with each correlation value of the peak correlation database identifies the timing location of a transmitted reference signal within the digitally-sampled communication signal.

In Example 10, the subject matter of any one of Examples 1 to 9 can optionally include wherein a reference signal identifier associated with each correlation value of the peak correlation database identifies the reference signal identity of a transmitted reference signal within the digitally-sampled communication signal.

In Example 11, the subject matter of any one of Examples 1 to 10 can optionally include wherein the one or more transmitted reference signals are each associated with a cell of a mobile communication network.

In Example 12, the subject matter of any one of Examples 1 to 11 can optionally include wherein each of the correlation values is associated with a digital sample of the digitally-sampled communication signal and a respective reference signal of a plurality of reference signals, and wherein the detecting one or more transmitted reference signals within the digitally-sampled communication signal using the peak correlation database includes detecting one or more transmitted reference signals within the digitally-sampled communication signal using the digital sample and the respective reference signal associated with each correlation value of the peak correlation database.

In Example 13, the subject matter of any one of Examples 1 to 12 can optionally further include calculating one or more additional correlation values, and applying the predefined criteria to the one or more additional correlation values to determine whether to exclude the one or more correlation values from the peak correlation database.

In Example 14, the subject matter of any one of Examples 1 to 13 can optionally further include identifying matching correlation values between the peak correlation database and an additional peak correlation database, the peak correlation database corresponding to a first time period of the digitally-sampled communication signal and the additional peak correlation database corresponding to a second time period of the digitally-sampled communication signal, and combining the peak correlation database and the additional peak correlation database based on the matching correlation values to obtain a merged peak correlation database.

In Example 15, the subject matter of Example 14 can optionally include wherein the second time period occurs after the first time period.

In Example 16, the subject matter of Example 14 can optionally include wherein the one or more transmitted reference signals occur periodically within the digitally-sampled communication signal with a period corresponding to the duration of the first time period and the second time period.

In Example 17, the subject matter of Example 14 can optionally include wherein the identifying matching correlation values between the peak correlation database and an additional peak correlation database includes identifying correlation values in the peak correlation database and the additional peak correlation database that are associated with identical reference signals and substantially equivalent input sample indices within the first time period and the second time period.

In Example 18, the subject matter of Example 14 can optionally include wherein the combining the peak correlation database and the additional peak correlation database based on the matching correlation values includes summing the matching correlation values to obtain corresponding summed correlation values, and storing the summed correlation values in the merged peak correlation database.

In Example 19, the subject matter of Example 14 can optionally include wherein the detecting one or more transmitted reference signals within the digitally-sampled communication signal using the peak correlation database includes detecting one or more transmitted reference signals within the digitally-sampled communication signal using the merged peak correlation database.

In Example 20, the subject matter of Example 1 can optionally include wherein the respective reference signal is one of a plurality of predefined reference signals.

In Example 21, the subject matter of any one of Examples 1 to 20 can optionally further include obtaining timing synchronization with one or more access points of a communication network based on the one or more transmitted reference signals detected within the digitally-sampled communication signal.

In Example 22, the subject matter of any one of Examples 1 to 21 can optionally further include obtaining identification information of one or more access points of a communication network based on the one or more transmitted reference signals detected within the digitally-sampled communication signal.

In Example 23, the subject matter of any one of Examples 1 to 22 can optionally include wherein the peak correlation database has a predefined capacity.

In Example 24, the subject matter of any one of Examples 1 to 23 can optionally include wherein the digitally-sampled communication signal is a mobile communication network signal.

In Example 25, the subject matter of any one of Examples 1 to 24 can optionally include wherein the digitally-sampled communication signal is a Long Term Evolution (LTE) signal.

In Example 26, the subject matter of any one of Examples 1 to 25 can optionally further include receiving a wireless communication signal, and digitally sampling the wireless communication signal to obtain the digitally-sampled communication signal.

In Example 27, the subject matter of Example 26 can optionally include wherein the wireless communication signal is a combined wireless communication signal containing wireless signals transmitted by one or more transmit terminals.

In Example 28, the subject matter of Example 27 can optionally include wherein the one or more transmit terminals are cells of a mobile communication network.

In Example 29, the subject matter of any one of Examples 1 to 28 can optionally further include calculating one or more additional correlation values, and applying the predefined criteria to the one or more additional correlation values in order to decide whether to exclude the one or more correlation values from an additional peak correlation database, wherein the peak correlation database corresponds to a first time period of the digitally-sampled communication signal and the additional peak correlation database corresponds to a second time period of the digitally-sampled communication signal.

In Example 30, the subject matter of Example 29 can optionally include wherein the second time period occurs after the first time period.

In Example 31, the subject matter of Example 29 can optionally include wherein the one or more transmitted reference signals occur periodically within the digitally-sampled communication signal with a period corresponding to the duration of the first time period and the second time period.

Example 32 is a method of detecting reference signals. The method includes calculating a plurality of correlation values as candidates for a peak correlation database, each correlation value representing a correlation between a digitally-sampled communication signal and a respective reference signal, repeatedly updating the peak correlation database by evaluating one or more of the plurality of correlation values to determine whether or not to store the one or more of the plurality of correlation values in the peak candidate database, and detecting one or more transmitted reference signals within the digitally-sampled communication signal using the peak correlation database.

In Example 33, the subject matter of Example 32 can optionally include wherein the repeatedly updating the peak correlation database by evaluating one or more of the plurality of correlation values to determine whether or not to store the one or more of the plurality of correlation values from the peak candidate database includes comparing the one or more of the plurality of correlation values to a plurality of correlation values of the peak correlation database.

In Example 34, the subject matter of Example 32 can optionally include wherein the repeatedly updating the peak correlation database by evaluating one or more of the plurality of correlation values to determine whether or not to store the one or more of the plurality of correlation values from the peak candidate database includes ranking the one or more of the plurality of correlation values against a plurality of correlation values of the peak correlation database to identify one or more maximum-valued correlation values, and storing the one or more maximum-value correlation values in the peak correlation database.

In Example 35, the subject matter of any one of Examples 32 to 34 can optionally include wherein the calculating a plurality of correlation values as candidates for a peak correlation database includes calculating the cross-correlation between digital samples of the digitally-sampled communication signal and each of a plurality of reference signals to generate the one or more correlation values.

In Example 36, the subject matter of Example 35 can optionally include wherein the plurality of reference signals are each associated with a cell of a mobile communication network.

In Example 37, the subject matter of Example 35 can optionally include wherein the plurality of reference signals are predefined synchronization sequences.

In Example 38, the subject matter of Example 37 can optionally include wherein the plurality of reference signals are Primary Synchronization Signals (PSSs).

In Example 39, the subject matter of any one of Examples 32 to 38 can optionally include wherein the detecting one or more transmitted reference signals within the digitally sampled communication signal using the peak correlation database includes identifying a digital sample of the digitally-sampled communication signal and a reference signal identifier associated with each correlation value of the peak correlation database.

In Example 40, the subject matter of Example 39 can optionally further include obtaining timing synchronization and identification information with a network cell based on the digital samples and reference signal identifiers associated with each correlation value of the peak correlation database.

In Example 41, the subject matter of any one of Examples 32 to 40 can optionally include wherein a digital sample of the digitally-sampled communication signal associated with each correlation value of the peak correlation database identifies the timing location of a transmitted reference signal within the digitally-sampled communication signal.

In Example 42, the subject matter of any one of Examples 32 to 41 can optionally include wherein a reference signal identifier associated with each correlation value of the peak correlation database identifies the reference signal identity of a transmitted reference signal within the digitally-sampled communication signal.

In Example 43, the subject matter of any one of Examples 32 to 42 can optionally include wherein each of the correlation values is associated with a digital sample of the digitally-sampled communication signal and a respective reference signal of a plurality of reference signals, and wherein the detecting one or more transmitted reference signals within the digitally-sampled communication signal using the peak correlation database includes detecting one or more transmitted reference signals within the digitally-sampled communication signal using the digital sample and the respective reference signal associated with each correlation value of the peak correlation database.

In Example 44, the subject matter of any one of Examples 32 to 43 can optionally further include comparing the peak correlation database with a second peak correlation database to identify one or more matching correlation values, the peak correlation database corresponding to a first time period of the digitally-sampled communication signal and the second peak correlation database corresponding to a second time period of the digitally-sampled communication signal, and combining the peak correlation database and the second peak correlation database based on the matching correlation values to obtain a merged peak correlation database.

In Example 45, the subject matter of Example 44 can optionally include wherein the second time period occurs after the first time period.

In Example 46, the subject matter of Example 44 can optionally include wherein the one or more transmitted reference signals occur periodically within the digitally-sampled communication signal with a period corresponding to the duration of the first time period and the second time period.

In Example 47, the subject matter of Example 44 can optionally include wherein the comparing the peak correlation database with a second peak correlation database to identify one or more matching correlation values includes identifying correlation values in the peak correlation database and the additional peak correlation database that are associated with identical reference signals and substantially equivalent input sample indices within the first time period and the second time period.

In Example 48, the subject matter of Example 44 can optionally include wherein the combining the peak correlation database and the second peak correlation database based on the matching correlation values to obtain a merged peak correlation database includes summing the matching correlation values to obtain corresponding summed correlation values, and storing the summed correlation values in the merged peak correlation database.

In Example 49, the subject matter of Example 44 can optionally include wherein the detecting one or more transmitted reference signals within the digitally-sampled communication signal using the peak correlation database includes detecting one or more transmitted reference signals within the digitally-sampled communication signal using the merged peak correlation database.

In Example 50, the subject matter of any one of Examples 32 to 49 can optionally further include obtaining timing synchronization with one or more access points of a communication network based on the one or more transmitted reference signals detected within the digitally-sampled communication signal.

In Example 51, the subject matter of any one of Examples 32 to 50 can optionally further include obtaining identification information of one or more access points of a communication network based on the one or more transmitted reference signals detected within the digitally-sampled communication signal.

In Example 52, the subject matter of any one of Examples 32 to 51 can optionally include wherein the peak correlation database has a predefined capacity.

In Example 53, the subject matter of any one of Examples 32 to 52 can optionally include wherein the digitally-sampled communication signal is a mobile communication network signal.

In Example 54, the subject matter of any one of Examples 32 to 53 can optionally include wherein the digitally sampled communication signal is a Long Term Evolution (LTE) signal.

In Example 55, the subject matter of any one of Examples 32 to 54 can optionally further include receiving a wireless communication signal, and digitally sampling the wireless communication signal to obtain the digitally-sampled communication signal.

In Example 56, the subject matter of Example 55 can optionally include wherein the wireless communication signal is a combined wireless communication signal containing wireless signals transmitted by one or more transmit terminals.

In Example 57, the subject matter of Example 56 can optionally include wherein the one or more transmit terminals are cells of a mobile communication network.

In Example 58, the subject matter of any one of Examples 32 to 57 can optionally further include calculating a second plurality of correlation values as candidates for a second peak correlation database, and repeatedly updating the additional peak correlation database by evaluating one or more of the second plurality of correlation values to determine whether or not to store the one or more of the second plurality of correlation values in the second peak candidate database, wherein the peak correlation database corresponds to a first time period of the digitally-sampled communication signal and the second peak correlation database corresponds to a second time period of the digitally-sampled communication signal.

In Example 59, the subject matter of Example 58 can optionally include wherein the second time period occurs after the first time period.

In Example 60, the subject matter of Example 58 can optionally include wherein the one or more transmitted reference signals occur periodically within digitally-sampled communication signal with a period corresponding to the duration of the first time period and the second time period.

In Example 61, the subject matter of Example 32 can optionally include wherein the respective reference signal is one of a plurality of predefined reference signals.

Example 62 is a mobile terminal device having a radio processing circuit and a baseband processing circuit adapted to interact with the radio processing circuit. The mobile terminal device is configured to calculate one or more correlation values, wherein each of the correlation values represents a correlation between a digitally-sampled communication signal and a respective reference signal, apply a predefined criteria to the one or more correlation values to determine whether to exclude the one or more correlation values from a peak correlation database, the peak correlation database containing the remaining one or more correlation values, and detect one or more transmitted reference signals within the digitally-sampled communication signal using the peak correlation database.

In Example 63, the subject matter of Example 62 can optionally further include a memory configured to store the peak correlation database.

In Example 64, the subject matter of Example 62 or 63 can optionally be configured to apply a predefined criteria to the one or more correlation values to determine whether to exclude the one or more correlation values from a peak correlation database by comparing the one or more correlation values to a plurality of correlation values in the peak correlation database.

In Example 65, the subject matter of any one of Examples 62 to 64 can optionally be configured to apply a predefined criteria to the one or more correlation values to determine whether to exclude the one or more correlation values from a peak correlation database by ranking the one or more correlation values against a plurality of correlation values of the peak correlation database to identify one or more maximum-valued correlation values, and retaining the one or more maximum-valued correlation values in the peak correlation database.

In Example 66, the subject matter of any one of Examples 62 to 65 can optionally be configured to calculate one or more correlation values by calculating the cross-correlation between digital samples of the digitally-sampled communication signal and each of a plurality of reference signals to generate the one or more correlation values.

In Example 67, the subject matter of Example 66 can optionally include wherein the plurality of reference signals are predefined synchronization sequences.

In Example 68, the subject matter of Example 67 can optionally include wherein the plurality of reference signals are Primary Synchronization Sequences (PSSs).

In Example 69, the subject matter of any one of Examples 62 to 68 can optionally include wherein the one or more transmitted reference signals are each associated with a cell of a mobile communication network.

In Example 70, the subject matter of any one of Examples 62 to 69 can optionally be configured to detect one or more transmitted reference signals within the digitally-sampled communication signal using the peak correlation database by identifying a digital sample of the digitally-sampled communication signal and a reference signal identifier associated with each correlation value of the peak correlation database.

In Example 71, the subject matter of Example 70 can optionally further include obtaining timing synchronization and identification information with a network cell based on the digital samples and reference signal identifiers associated with each correlation value of the peak correlation database.

In Example 72, the subject matter of any one of Examples 62 to 71 can optionally include wherein a digital sample of the digitally-sampled communication signal associated with each correlation value of the peak correlation database identifies the timing location of a transmitted reference signal within the digitally-sampled communication signal.

In Example 73, the subject matter of any one of Examples 62 to 72 can optionally include wherein a reference signal identifier associated with each correlation value of the peak correlation database identifies the reference signal identity of a transmitted reference signal within the digitally-sampled communication signal.

In Example 74, the subject matter of any one of Examples 62 to 73 can optionally include wherein each of the correlation values is associated with a digital sample of the digitally-sampled communication signal and a respective reference signal of a plurality of reference signals, and wherein the mobile terminal device is configured to detect one or more transmitted reference signals within the digitally-sampled communication signal using the peak correlation database includes detecting one or more transmitted reference signals within the digitally-sampled communication signal using the digital sample and the respective reference signal associated with each correlation value of the peak correlation database.

In Example 75, the subject matter of any one of Examples 62 to 74 can optionally be further configured to calculate one or more additional correlation values, apply the predefined criteria to the one or more additional correlation values to determine whether to exclude the one or more correlation values from the peak correlation database.

In Example 76, the subject matter of any one of Examples 62 to 75 can optionally be further configured to identify matching correlation values between the peak correlation database and an additional peak correlation database, the peak correlation database corresponding to a first time period of the digitally-sampled communication signal and the additional peak correlation database corresponding to a second time period of the digitally-sampled communication signal, and combine the peak correlation database and the additional peak correlation database based on the matching correlation values to obtain a merged peak correlation database.

In Example 77, the subject matter of Example 76 can optionally include wherein the second time period occurs after the first time period.

In Example 78, the subject matter of Example 76 can optionally include wherein the one or more transmitted reference signals occur periodically within the digitally-sampled communication signal with a period corresponding to the duration of the first time period and the second time period.

In Example 79, the subject matter of Example 76 can optionally be configured to identify matching correlation values between the peak correlation database and an additional peak correlation database by identifying correlation values in the peak correlation database and the additional peak correlation database that are associated with identical reference signals and substantially equivalent input sample indices within the first time period and the second time period.

In Example 80, the subject matter of Example 76 can optionally be configured to combine the peak correlation database and the additional peak correlation database based on the matching correlation values by summing the matching correlation values to obtain corresponding summed correlation values, and storing the summed correlation values in the merged peak correlation database.

In Example 81, the subject matter of Example 76 can optionally include configured to detect one or more transmitted reference signals within the digitally-sampled communication signal using the peak correlation database by detecting one or more transmitted reference signals within the digitally-sampled communication signal using the merged peak correlation database.

In Example 82, the subject matter of any one of Examples 62 to 81 can optionally include wherein the respective reference signal is one of a plurality of predefined reference signals.

In Example 83, the subject matter of Example 82 can optionally be further configured to obtain timing synchronization with one or more access points of a communication network based on the one or more transmitted reference signals detected within the digitally-sampled communication signal.

In Example 84, the subject matter of Example 83 can optionally be further configured to obtain identification information of one or more access points of a communication network based on the one or more transmitted reference signals detected within the digitally-sampled communication signal.

In Example 85, the subject matter of any one of Examples 62 to 84 can optionally include wherein the peak correlation database has a predefined capacity.

In Example 86, the subject matter of any one of Examples 62 to 85 can optionally include wherein the digitally-sampled communication signal is a mobile communication network signal.

In Example 87, the subject matter of any one of Examples 62 to 86 can optionally include wherein the digitally-sampled communication signal is a Long Term Evolution (LTE) signal.

In Example 88, the subject matter of any one of Examples 62 to 87 can optionally be further configured to receive a wireless communication signal, and digitally sample the wireless communication signal to obtain the digitally-sampled communication signal.

In Example 89, the subject matter of Example 88 can optionally include wherein the wireless communication signal is a combined wireless communication signal containing wireless signals transmitted by one or more transmit terminals.

In Example 90, the subject matter of Example 89 can optionally include wherein the one or more transmit terminals are cells of a mobile communication network.

In Example 91, the subject matter of any one of Examples 62 to 90 can optionally be further configured to calculate one or more additional correlation values, and apply the predefined criteria to the one or more additional correlation values to determine whether to exclude the one or more correlation values from an additional peak correlation database, wherein the peak correlation database corresponds to a first time period of the digitally-sampled communication signal and the additional peak correlation database corresponds to a second time period of the digitally-sampled communication signal.

In Example 92, the subject matter of Example 91 can optionally include wherein the second time period occurs after the first time period.

In Example 93, the subject matter of Example 92 can optionally include wherein the one or more transmitted reference signals occur periodically within the digitally-sampled communication signal with a period corresponding to the duration of the first time period and the second time period.

Example 94 is a mobile terminal device having a radio processing circuit and a baseband processing circuit adapted to interact with the radio processing circuit. The mobile terminal device is configured to calculate a plurality of correlation values as candidates for a peak correlation database, each correlation value representing a correlation between a digitally-sampled communication signal and a respective reference signal, repeatedly update the peak correlation database by evaluating one or more of the plurality of correlation values to determine whether or not to store the one or more of the plurality of correlation values in the peak candidate database, and detect one or more transmitted reference signals within the digitally-sampled communication signal using the peak correlation database.

In Example 95, the subject matter of Example 94 can optionally include a memory configured to store the peak correlation database.

In Example 96, the subject matter of Example 94 or 95 can optionally be configured to repeatedly update the peak correlation database by evaluating one or more of the plurality of correlation values to determine whether or not to store the one or more of the plurality of correlation values from the peak candidate database by comparing the one or more of the plurality of correlation values to a plurality of correlation values of the peak correlation database.

In Example 97, the subject matter of any one of Examples 94 to 96 can optionally be configured to repeatedly update the peak correlation database by evaluating one or more of the plurality of correlation values to determine whether or not to store the one or more of the plurality of correlation values from the peak candidate database by ranking the one or more of the plurality of correlation values against a plurality of correlation values of the peak correlation database to identify one or more maximum-valued correlation values, and storing only the one or more maximum-value correlation values in the peak correlation database.

In Example 98, the subject matter of any one of Examples 94 to 97 can optionally be configured to calculate a plurality of correlation values as candidates for a peak correlation database by calculating the cross-correlation between digital samples of the digitally-sampled communication signal and each of a plurality of reference signals to generate the one or more correlation values.

In Example 99, the subject matter of Example 98 can optionally include wherein the plurality of reference signals are each associated with a cell of a mobile communication network.

In Example 100, the subject matter of any one of Examples the plurality of can optionally include signals are predefined synchronization sequences.

In Example 101, the subject matter of Example 100 can optionally include wherein the plurality of reference signals are Primary Synchronization Sequences (PSSs).

In Example 102, the subject matter of any one of Examples 94 to 101 can optionally be configured to detect one or more transmitted reference signals within the digitally-sampled communication signal using the peak correlation database by identifying a digital sample of the digitally-sampled communication signal and a reference signal identifier associated with each correlation value of the peak correlation database.

In Example 103, the subject matter of Example 102 can optionally further include obtaining timing synchronization and identification information with a network cell based on the digital samples and reference signal identifiers associated with each correlation value of the peak correlation database.

In Example 104, the subject matter of any one of Examples 94 to 103 can optionally include wherein a digital sample of the digitally-sampled communication signal associated with each correlation value of the peak correlation database identifies the timing location of a transmitted reference signal within the digitally-sampled communication signal.

In Example 105, the subject matter of any one of Examples 94 to 104 can optionally include wherein a reference signal identifier associated with each correlation value of the peak correlation database identifies the reference signal identity of a transmitted reference signal within the digitally-sampled communication signal.

In Example 106, the subject matter of any one of Examples 94 to 105 can optionally be configured to detect one or more transmitted reference signals within the digitally-sampled communication signal using the peak correlation database by identifying a digital sample of the digitally-sampled communication signal and a reference signal identifier associated with each correlation value of the peak correlation database.

In Example 107, the subject matter of any one of Examples 94 to 106 can optionally include wherein each of the correlation values is associated with a digital sample of the digitally-sampled communication signal and a respective reference signal of a plurality of reference signals, and wherein the mobile terminal device is configured to detect one or more transmitted reference signals within the digitally-sampled communication signal using the peak correlation database by detecting one or more transmitted reference signals within the digitally-sampled communication signal using the digital sample and the respective reference signal associated with each correlation value of the peak correlation database.

In Example 108, the subject matter of any one of Examples 94 to 107 can optionally be further configured to compare the peak correlation database with a second peak correlation database to identify one or more matching correlation values, the peak correlation database corresponding to a first time period of the digitally-sampled communication signal and the second peak correlation database corresponding to a second time period of the digitally-sampled communication signal, and combine the peak correlation database and the second peak correlation database based on the matching correlation values to obtain a merged peak correlation database.

In Example 109, the subject matter of Example 108 can optionally include wherein the second time period occurs after the first time period.

In Example 110, the subject matter of Example 108 can optionally include wherein the one or more transmitted reference signals occur periodically within the digitally-sampled communication signal with a period corresponding to the duration of the first time period and the second time period.

In Example 111, the subject matter of Example 108 can optionally be configured to compare the peak correlation database with a second peak correlation database to identify one or more matching correlation values by identifying correlation values in the peak correlation database and the additional peak correlation database that are associated with identical reference signals and substantially equivalent input sample indices within the first time period and the second time period.

In Example 112, the subject matter of Example 111 can optionally be configured to combine the peak correlation database and the second peak correlation database based on the matching correlation values to obtain a merged peak correlation database by summing the matching correlation values to obtain corresponding summed correlation values, and storing the summed correlation values in the merged peak correlation database.

In Example 113, the subject matter of Example 108 can optionally be configured to detect one or more transmitted reference signals within the digitally-sampled communication signal using the peak correlation database by detecting one or more transmitted reference signals within the digitally-sampled communication signal using the merged peak correlation database.

In Example 114, the subject matter of any one of Examples 94 to 113 can optionally be further configured to obtain timing synchronization with one or more access points of a communication network based on the one or more transmitted reference signals detected within the digitally-sampled communication signal.

In Example 115, the subject matter of any one of Examples 94 to 114 can optionally be further configured to obtain identification information of one or more access points of a communication network based on the one or more transmitted reference signals detected within the digitally-sampled communication signal.

In Example 116, the subject matter of any one of Examples 94 to 115 can optionally include wherein the peak correlation database has a predefined capacity.

In Example 117, the subject matter of any one of Examples 94 to 116 can optionally include wherein the digitally-sampled communication signal is a mobile communication network signal.

In Example 118, the subject matter of any one of Examples 94 to 117 can optionally include wherein the digitally sampled communication signal is a Long Term Evolution (LTE) signal.

In Example 119, the subject matter of any one of Examples 94 to 118 can optionally be further configured to receive a wireless communication signal, and digitally sample the wireless communication signal to obtain the digitally-sampled communication signal.

In Example 120, the subject matter of Example 119 can optionally include wherein the wireless communication signal is a combined wireless communication signal containing wireless signals transmitted by one or more transmit terminals.

In Example 121, the subject matter of Example 120 can optionally include wherein the one or more transmit terminals are cells of a mobile communication network.

In Example 122, the subject matter of any one of Examples 94 to 121 can optionally be further configured to calculate a second plurality of correlation values as candidates for a second peak correlation database, and repeatedly update the additional peak correlation database by evaluating one or more of the second plurality of correlation values to determine whether or not to store the one or more of the second plurality of correlation values in the second peak candidate database, wherein the peak correlation database corresponds to a first time period of the digitally-sampled communication signal and the second peak correlation database corresponds to a second time period of the digitally-sampled communication signal.

In Example 123, the subject matter of Example 122 can optionally include wherein the second time period occurs after the first time period.

In Example 124, the subject matter of Example 122 can optionally include wherein the one or more transmitted reference signals occur periodically within digitally-sampled communication signal with a period corresponding to the duration of the first time period and the second time period.

In Example 125, the subject matter of any one of Examples 94 to 124 can optionally include wherein the respective reference signal is one of a plurality of predefined reference signals.

Example 126 is a mobile baseband modem having one or more digital processing circuits and a memory. The mobile baseband modem is configured to calculate a plurality of correlation values as candidates for a peak correlation database, each correlation value representing a correlation between a digitally-sampled communication signal and a respective reference signal, repeatedly update the peak correlation database by evaluating one or more of the plurality of correlation values to determine whether or not to store the one or more of the plurality of correlation values in the peak candidate database, and detect one or more transmitted reference signals within the digitally-sampled communication signal using the peak correlation database.

In Example 127, the subject matter of Example 126 can optionally include wherein the memory is configured to store the peak correlation database.

In Example 128, the subject matter of Example 126 or 127 can optionally be configured to repeatedly update the peak correlation database by evaluating one or more of the plurality of correlation values to determine whether or not to store the one or more of the plurality of correlation values from the peak candidate database by comparing the one or more of the plurality of correlation values to a plurality of correlation values of the peak correlation database.

In Example 129, the subject matter of any one of Examples 126 to 128 can optionally be configured to repeatedly update the peak correlation database by evaluating one or more of the plurality of correlation values to determine whether or not to store the one or more of the plurality of correlation values from the peak candidate database by ranking the one or more of the plurality of correlation values against a plurality of correlation values of the peak correlation database to identify one or more maximum-valued correlation values, and storing only the one or more maximum-value correlation values in the peak correlation database.

In Example 130, the subject matter of any one of Examples 126 to 129 can optionally be configured to calculate a plurality of correlation values as candidates for a peak correlation database by calculating the cross-correlation between digital samples of the digitally-sampled communication signal and each of a plurality of reference signals to generate the one or more correlation values.

In Example 131, the subject matter of Example 130 can optionally include wherein the plurality of reference signals are each associated with a cell of a mobile communication network.

In Example 132, the subject matter of Example 130 can optionally include wherein the plurality of reference signals are predefined synchronization sequences.

In Example 133, the subject matter of Example 132 can optionally include wherein the plurality of reference signals are Primary Synchronization Signals (PSSs).

In Example 134, the subject matter of any one of Examples 126 to 133 can optionally be configured to detect one or more transmitted reference signals within the digitally-sampled communication signal using the peak correlation database by identifying a digital sample of the digitally-sampled communication signal and a reference signal identifier associated with each correlation value of the peak correlation database.

In Example 135, the subject matter of any one of Examples 126 to 134 can optionally further include obtaining timing synchronization and identification information with a network cell based on the digital samples and reference signal identifiers associated with each correlation value of the peak correlation database.

In Example 136, the subject matter of any one of Examples 126 to 135 can optionally include wherein a digital sample of the digitally-sampled communication signal associated with each correlation value of the peak correlation database identifies the timing location of a transmitted reference signal within the digitally-sampled communication signal.

In Example 137, the subject matter of any one of Examples 126 to 136 can optionally include wherein a reference signal identifier associated with each correlation value of the peak correlation database identifies the reference signal identity of a transmitted reference signal within the digitally-sampled communication signal.

In Example 138, the subject matter of any one of Examples 126 to 137 can optionally include wherein each of the correlation values is associated with a digital sample of the digitally-sampled communication signal and a respective reference signal of a plurality of reference signals, and wherein the mobile baseband modem is configured to detect one or more transmitted reference signals within the digitally-sampled communication signal using the peak correlation database by detecting one or more transmitted reference signals within the digitally-sampled communication signal using the digital sample and the respective reference signal associated with each correlation value of the peak correlation database.

In Example 139, the subject matter of any one of Examples 126 to 138 can optionally be further configured to compare the peak correlation database with a second peak correlation database to identify one or more matching correlation values, the peak correlation database corresponding to a first time period of the digitally-sampled communication signal and the second peak correlation database corresponding to a second time period of the digitally-sampled communication signal, and combine the peak correlation database and the second peak correlation database based on the matching correlation values to obtain a merged peak correlation database.

In Example 140, the subject matter of Example 139 can optionally include wherein the second time period occurs after the first time period.

In Example 141, the subject matter of Example 139 can optionally include wherein the one or more transmitted reference signals occur periodically within the digitally-sampled communication signal with a period corresponding to the duration of the first time period and the second time period.

In Example 142, the subject matter of Example 139 can optionally be configured to compare the peak correlation database with a second peak correlation database to identify one or more matching correlation values by identifying correlation values in the peak correlation database and the additional peak correlation database that are associated with identical reference signals and substantially equivalent input sample indices within the first time period and the second time period.

In Example 143, the subject matter of Example 142 can optionally be configured to combine the peak correlation database and the second peak correlation database based on the matching correlation values to obtain a merged peak correlation database by summing the matching correlation values to obtain corresponding summed correlation values, and storing the summed correlation values in the merged peak correlation database.

In Example 144, the subject matter of Example 139 can optionally be configured to detect one or more transmitted reference signals within the digitally-sampled communication signal using the peak correlation database by detecting one or more transmitted reference signals within the digitally-sampled communication signal using the merged peak correlation database.

In Example 145, the subject matter of any one of Examples 126 to 144 can optionally be further configured to obtain timing synchronization with one or more access points of a communication network based on the one or more transmitted reference signals detected within the digitally-sampled communication signal.

In Example 146, the subject matter of any one of Examples 126 to 145 can optionally be further configured to obtain identification information of one or more access points of a communication network based on the one or more transmitted reference signals detected within the digitally-sampled communication signal.

In Example 147, the subject matter of any one of Examples 126 to 146 can optionally include wherein the peak correlation database has a predefined capacity.

In Example 148, the subject matter of any one of Examples 126 to 147 can optionally include wherein the digitally-sampled communication signal is a mobile communication network signal.

In Example 149, the subject matter of any one of Examples 126 to 148 can optionally include wherein the digitally sampled communication signal is a Long Term Evolution (LTE) signal.

In Example 150, the subject matter of any one of Examples 126 to 149 can optionally be further configured to receive a wireless communication signal, and digitally sample the wireless communication signal to obtain the digitally-sampled communication signal.

In Example 151, the subject matter of Example 150 can optionally include wherein the wireless communication signal is a combined wireless communication signal containing wireless signals transmitted by one or more transmit terminals.

In Example 152, the subject matter of Example 151 can optionally include wherein the one or more transmit terminals are cells of a mobile communication network.

In Example 153, the subject matter of Example 151 can optionally be further configured to calculate a second plurality of correlation values as candidates for a second peak correlation database, and repeatedly update the additional peak correlation database by evaluating one or more of the second plurality of correlation values to determine whether or not to store the one or more of the second plurality of correlation values in the second peak candidate database, wherein the peak correlation database corresponds to a first time period of the digitally-sampled communication signal and the second peak correlation database corresponds to a second time period of the digitally-sampled communication signal.

In Example 154, the subject matter of Example 153 can optionally include wherein the second time period occurs after the first time period.

In Example 155, the subject matter of Example 153 can optionally include wherein the one or more transmitted reference signals occur periodically within digitally-sampled communication signal with a period corresponding to the duration of the first time period and the second time period.

In Example 156, the subject matter of any one of Examples 126 to 155 can optionally include wherein the respective reference signal is one of a plurality of predefined reference signals.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A mobile terminal device having a radio processing circuit and a baseband processing circuit adapted to interact with the radio processing circuit, the mobile terminal device configured to:
calculate a plurality of correlation values as candidates for a peak correlation database, each correlation value representing a correlation between a digitally-sampled communication signal and a respective reference signal;
repeatedly update the peak correlation database by evaluating one or more of the plurality of correlation values to determine whether or not to store the one or more of the plurality of correlation values in the peak candidate database; and
detect one or more transmitted reference signals within the digitally-sampled communication signal using the peak correlation database.

2. The mobile terminal device of claim 1, configured to repeatedly update the peak correlation database by evaluating one or more of the plurality of correlation values to determine whether or not to store the one or more of the plurality of correlation values from the peak candidate database by:
comparing the one or more of the plurality of correlation values to a plurality of correlation values of the peak correlation database.

3. The mobile terminal device of claim 1, configured to repeatedly update the peak correlation database by evaluating one or more of the plurality of correlation values to determine whether or not to store the one or more of the plurality of correlation values from the peak candidate database by:
ranking the one or more of the plurality of correlation values against a plurality of correlation values of the peak correlation database to identify one or more maximum-valued correlation values; and
storing only the one or more maximum-value correlation values in the peak correlation database.

4. The mobile terminal device of claim 1, configured to calculate a plurality of correlation values as candidates for a peak correlation database by:
calculating the cross-correlation between digital samples of the digitally-sampled communication signal and each of a plurality of reference signals to generate the one or more correlation values.

5. The mobile terminal device of claim 1, wherein each of the correlation values is associated with a digital sample of the digitally-sampled communication signal and a respective reference signal of a plurality of reference signals,
and wherein the mobile terminal device is configured to detect one or more transmitted reference signals within the digitally-sampled communication signal using the peak correlation database by:
detecting one or more transmitted reference signals within the digitally-sampled communication signal using the digital sample and the respective reference signal associated with each correlation value of the peak correlation database.

6. The mobile terminal device of claim 1, further configured to:
compare the peak correlation database with a second peak correlation database to identify one or more matching correlation values, the peak correlation database corresponding to a first time period of the digitally-sampled communication signal and the second peak correlation database corresponding to a second time period of the digitally-sampled communication signal; and
combine the peak correlation database and the second peak correlation database based on the matching correlation values to obtain a merged peak correlation database.

7. The mobile terminal device of claim 6, configured to detect one or more transmitted reference signals within the digitally-sampled communication signal using the peak correlation database by:
detecting one or more transmitted reference signals within the digitally-sampled communication signal using the merged peak correlation database.

8. A mobile terminal device having a radio processing circuit and a baseband processing circuit adapted to interact with the radio processing circuit, the mobile terminal device configured to:
calculate one or more correlation values, wherein each of the correlation values represents a correlation between a digitally-sampled communication signal and a respective reference signal;
apply a predefined criteria to the one or more correlation values to determine whether to exclude the one or more correlation values from a peak correlation database, the peak correlation database containing the remaining one or more correlation values; and
detect one or more transmitted reference signals within the digitally-sampled communication signal using the peak correlation database.

9. The mobile terminal device of claim 8, configured to apply a predefined criteria to the one or more correlation values to determine whether to exclude the one or more correlation values from a peak correlation database by:
comparing the one or more correlation values to a plurality of correlation values in the peak correlation database.

10. The mobile terminal device of claim 8, configured to apply a predefined criteria to the one or more correlation values to determine whether to exclude the one or more correlation values from a peak correlation database by:
ranking the one or more correlation values against a plurality of correlation values of the peak correlation database to identify one or more maximum-valued correlation values; and
retaining the one or more maximum-valued correlation values in the peak correlation database.

11. The mobile terminal device of claim 8, configured to calculate one or more correlation values by:
calculating the cross-correlation between digital samples of the digitally-sampled communication signal and each of a plurality of reference signals to generate the one or more correlation values.

12. The mobile terminal device of claim 8, wherein each of the correlation values is associated with a digital sample of the digitally-sampled communication signal and a respective reference signal of a plurality of reference signals,
and wherein the mobile terminal device is configured to detect one or more transmitted reference signals within the digitally-sampled communication signal using the peak correlation database comprises:
detecting one or more transmitted reference signals within the digitally-sampled communication signal using the digital sample and the respective reference signal associated with each correlation value of the peak correlation database.

13. The mobile terminal device of claim 8, further configured to:
calculate one or more additional correlation values;
apply the predefined criteria to the one or more additional correlation values to determine whether to exclude the one or more correlation values from the peak correlation database.

14. The mobile terminal device of claim 8, further configured to:
identify matching correlation values between the peak correlation database and an additional peak correlation database, the peak correlation database corresponding to a first time period of the digitally-sampled communication signal and the additional peak correlation database corresponding to a second time period of the digitally-sampled communication signal; and
combine the peak correlation database and the additional peak correlation database based on the matching correlation values to obtain a merged peak correlation database.

15. The mobile terminal device of claim 14, configure to detect one or more transmitted reference signals within the digitally-sampled communication signal using the peak correlation database by:
detecting one or more transmitted reference signals within the digitally-sampled communication signal using the merged peak correlation database.

16. A method of detecting reference signals comprising:
calculating a plurality of correlation values as candidates for a peak correlation database, each correlation value representing a correlation between a digitally-sampled communication signal and a respective reference signal;
repeatedly updating the peak correlation database by evaluating one or more of the plurality of correlation values to determine whether or not to store the one or more of the plurality of correlation values in the peak candidate database; and
detecting one or more transmitted reference signals within the digitally-sampled communication signal using the peak correlation database.

17. The method of claim 16, wherein the repeatedly updating the peak correlation database by evaluating one or more of the plurality of correlation values to determine whether or not to store the one or more of the plurality of correlation values from the peak candidate database comprises:
comparing the one or more of the plurality of correlation values to a plurality of correlation values of the peak correlation database.

18. The method of claim 16, wherein the repeatedly updating the peak correlation database by evaluating one or more of the plurality of correlation values to determine whether or not to store the one or more of the plurality of correlation values from the peak candidate database comprises:
ranking the one or more of the plurality of correlation values against a plurality of correlation values of the peak correlation database to identify one or more maximum-valued correlation values; and
storing the one or more maximum-value correlation values in the peak correlation database.

19. The method of claim 16, wherein each of the correlation values is associated with a digital sample of the digitally-sampled communication signal and a respective reference signal of a plurality of reference signals,
and wherein the detecting one or more transmitted reference signals within the digitally-sampled communication signal using the peak correlation database comprises:
detecting one or more transmitted reference signals within the digitally-sampled communication signal using the digital sample and the respective reference signal associated with each correlation value of the peak correlation database.

20. The method of claim 16, further comprising:
comparing the peak correlation database with a second peak correlation database to identify one or more matching correlation values, the peak correlation database corresponding to a first time period of the digitally-sampled communication signal and the second peak correlation database corresponding to a second time period of the digitally-sampled communication signal; and
combining the peak correlation database and the second peak correlation database based on the matching correlation values to obtain a merged peak correlation database.
